(19) United States
(12) Patent Application Publication
(10) Pub. No.: US 2018/0211227 A1
(43) Pub. Date: Jul. 26, 2018

(54) SYSTEM AND METHOD FOR DYNAMIC ASSISTANT PREDICTION

(71) Applicant: Madison Alexandra Jones, Slidell, LA (US)

(72) Inventor: Madison Alexandra Jones, Slidell, LA (US)

(21) Appl. No.: 15/877,189

(22) Filed: Jan. 22, 2018

Related U.S. Application Data
(60) Provisional application No. 62/449,026, filed on Jan. 22, 2017.

(51) Int. Cl. G06Q 10/10; G06Q 10/06

(52) U.S. Cl. CPC G06Q 10/1053; G06Q 10/0639

(57) ABSTRACT

A system and method for predicting candidate compatibility for network-connected assistant user devices and supervisor user devices connected, via a network, to a dynamic assistant prediction computer comprising a memory and a processor and further comprising programmable instructions stored in the memory and operating on the processor, the programmable instructions adapted to dynamically predict an assistant comprising an assistant reference network, a device workflow parser, a verification manager, a dynamic matching manager, a reference network displayer, a messaging manager, a housing manager, a supervisor manager, and an assistant manager for matching assistant devices and supervisor devices based on pre-configured criteria.

### CROSS REFERENCE TO RELATED APPLICATIONS

This application claims the benefit of, and priority to, U.S. provisional application 62/449,026 titled, “SYSTEM AND METHOD FOR DYNAMIC ASSISTANT PREDICTION” filed on Jan. 22, 2017, the entire specification of which is incorporated herein by reference.

### FIELD OF THE INVENTION

The disclosure as detailed herein is in the technical field of technical prediction systems. More specifically, the present disclosure relates to the technical field of quantified predictive persona matching.

### DESCRIPTION OF RELATED ART

Personal assistant positions are on a need-based system, and it is difficult to determine who is in need of a personal assistant. Moreover, obtaining these positions is usually based on referrals, so without an extensive network, it is difficult for someone to find a new position. Normally, extensive networks are established through third party systems, but these are without a mechanism to determine the value to inside network and outside network parties. Current systems do not allow an evaluator to examine the associations of a network member to evaluate job capabilities.

The hiring process for personal assistants is also difficult in terms of vetting and negotiating pay and benefits. When hiring a personal assistant, an interview is usually the extent of the vetting process for a supervisor. However, it is difficult to determine personality types and compatibility between personal assistant and supervisor based solely on an interview. Although testimonials can provide a high value for a personal assistant, they can be uncomfortable to obtain, may not be fair, and are difficult to present via a resume.

Supervisors also often have specific technical skills and requirements as part of their job description. Resumes may not address all the skills that a personal assistant may have. Furthermore, during the interview process, a supervisor may not remember all the skills that the personal assistant listed on their resume.

Similarly, it is difficult for personal assistants to vet potential supervisors and their needs prior to commencing work. Information they are able to obtain is usually after they are hired and often from tangential sources, which may be unreliable. This can make it difficult to determine job descriptions and requirements, and even engender safety issues for personal assistants. Because the work environment for personal assistants is both very personal and very professional, in this non-structured environment, it can be hard to distinguish which assignments are personal work and which are professional work.

Furthermore, performance criteria and set rate standards usually are not publicly available. Without these, it is difficult for experienced or skilled personal assistants to establish their value and negotiate pay and benefits. Benefits are usually lacking, with holiday and vacation benefits difficult for supervisors to accept as part of an economic package.

Conversations about pay are necessary but divert valuable time away from actual work and to discussion of pay issues instead. Personal assistants may have to establish work hour accountability to track productivity, buy may lack an existing infrastructure, such as a payroll system, which can cause pay to be unreliable, thereby allowing for conflict.

Personal assistant positions are often temporary; therefore, a personal assistant's income can be stochastic and lack economic stability. And although job transitions occur frequently, having a high number of positions of limited duration is not necessarily indicative of a lack of employability. Moreover, frequent transitions necessitate repeated conversations about a personal assistant's availability, and this scheduling can be difficult to do in a non-structured environment.

Travel is often necessary for supervisors and it can be hard to determine if a personal assistant can meet the travel requirements of their supervisor. The means for denoting travel experience are limited when seeking employment, so it can be difficult for a personal assistant to communicate their travel experience to potential supervisors. It can be difficult for a personal assistant to communicate their willingness to travel, to clearly demarcate their bounds of travel, and to clearly demarcate the languages necessary to travel. Furthermore, finding travel accommodations for personal assistants and supervisors can be difficult in terms of matching housing requirements with the destination travel market.

Supervisors require confidentiality when working with a personal assistant, but it is difficult to evaluate whether someone is trustworthy and discreet with confidential information. Similarly, a personal assistant's personality is vital to their job performance but evaluating their personality is time consuming, and difficult to accomplish, whether because existing standards for displaying multiple personality data for surveying assistants does not exist, or because assaying an individual's personality data is difficult to understand without standard visual iconography.

Searching for a new personal assistant requires a lot of time to properly vet candidates and to manage the hiring process. This can be costly and time prohibitive. Hiring new personal assistants is often done on a referral basis, but without an extensive network, it can be difficult to hire a personal assistant that matches the supervisor's needs. When working with new personal assistants, information about them is often gathered from tangential or third-party sources. These sources may not be reliable, may engender confidentiality issues, and this may make it difficult for supervisors to determine applicants' ability to fulfill the job description and requirements.

Typically, there are no publicly available set rate standards or measurements for duties performed by a personal assistant. It is also difficult for supervisors to match their quality requirements for these standards and measurements to an economic value for personal assistants, and therefore, it is hard to establish an offer.

Supervisors often rely on personal assistants to self-report work hours and productivity, potentially leading to fraudulent accounting. Therefore, supervisors often need to establish work hour accountability mechanisms to track personal assistant productivity, but this can be time consuming and costly to implement, and can require knowledge or skill sets that the supervisor may be lacking.

Supervisors may require different personal assistants for different purposes and/or at different rates, but it is hard to evaluate multiple personal assistants and skill sets through networking or interviews. Supervisors may find it necessary to communicate varying job descriptions and environments to potential personal assistants, but it can be difficult to filter applicants based on the supervisor's job requirements.

Supervisor's often have specific technical skills and requirements as part of their job description, but these can be difficult to evaluate via a resume. While testimonials from previous employers have high value when evaluating a personal assistant, testimonials can be time-consuming to write, and testimonials can be difficult to evaluate through non-standardized means.

Supervisors also need to be able to evaluate the past performance of a personal assistant to determine their future job performance. The personal assistant's resume may be ambiguous regarding desired job requirements, however, and they may or may not be skilled. A resume can easily be fraudulent altogether.

Similarly, evaluation of a personal assistant's resume references is also necessary to determine their future job performance, but it is time consuming and often difficult to track down references.

Supervisors often require the ability to travel of their personal assistants. It is difficult for them to determine if a personal assistant can meet this requirement. It is also difficult for a supervisor to evaluate a personal assistant's language capabilities relevant to the travel that is required. Similarly, a supervisor and a personal assistant may require travel accommodations and it can be difficult to match housing requirements with the destination travel market. Sometimes, a personal assistant may be required in a city in which a supervisor does not have a network. It can be difficult to gain access to that network due to language barriers or cultural differences.

### General Summary of the Invention

### DESCRIPTION OF FIGURES

FIG. 1 is a diagram view which shows an exemplary hardware architecture of a computing device used in an embodiment of the invention.

FIG. 2 is a diagram view which shows an exemplary logical architecture for a client device, according to an embodiment of the invention.

FIG. 3 is a diagram view which shows an exemplary architectural arrangement of clients, servers, and external services, according to an embodiment of the invention.

FIG. 4 is a diagram view which shows an embodiment of a hardware architecture of a computing device used in various embodiments of the invention.

FIG. 5 is a diagram view which shows relationships of the DAPS, it's submodules and network connections to devices.

FIG. 6 is a diagram view which shows relationships of the assistant ethos work ethic submitter module and its submodules.

FIG. 7 is a diagram view which shows relationships of the analytical personality submitter module and its submodules.

FIG. 8 is a diagram view which shows relationships of the driver personality submitter module and its submodules.

FIG. 9 is a diagram view which shows relationships of the amiable personality submitter module and its submodules.

FIG. 10 is a diagram view which shows relationships of the expressive personality submitter module and its submodules.

FIG. 11 is a diagram view which shows relationships of the assistant ethos submitter module and its submodules.

FIG. 12 is a diagram view which shows relationships of the assistant registration displayer module and its submodules.

FIG. 13 is a diagram view which shows relationships of the analytical personality object module and its submodules.

FIG. 14 is a diagram view which shows relationships of the driver personality object module and its submodules.

FIG. 15 is a diagram view which shows relationships of the amiable personality object module and its submodules.

FIG. 16 is a diagram view which shows relationships of the expressive personality object module and its submodules.

FIG. 17 is a diagram view which shows relationships of the assistant ethos personality object module and its submodules.

FIG. 18 is a diagram view which shows relationships of the assistant ethos work ethic object module and its submodules.

FIG. 19 is a diagram view which shows relationships of the assistant registration object module and its submodules.

FIG. 20 is a diagram view which shows relationships of the assistant manager module and its submodules.

FIG. 21 is a diagram view which shows relationships of the reference network displayer module and its submodules.

FIG. 22 is a diagram view which shows relationships of the supervisor registrar module and its submodules.

FIG. 23 is a diagram view which shows relationships of the supervisor multi-assistant displayer module and its submodules.

FIG. 24 is a diagram view which shows relationships of the supervisor manager module and its submodules.

FIG. 25 is a diagram view which shows relationships of the dynamic matching manager module and its submodules.

FIG. 26 is a diagram view which shows overall use of the system.

FIG. 27 is a diagram view which shows interaction with the supervisor search submitter.

FIG. 28 is a diagram view which shows interaction with the supervisor multi assistant displayer.

FIG. 29 is a diagram view which shows registration for the DAPS.

FIG. 30 is a diagram view which shows registration of an assistant device.

FIG. 31 is a diagram view which shows assistant registration object configuration.

FIG. 32 is a diagram view which shows assistant ethos personality object configuration.

FIG. 33 is a diagram view which shows registration of the supervisor device.

FIG. 34 is a diagram view which shows interacting with the assistant workflow decider.

FIG. 35 is a diagram view which shows interacting with the messaging manager.

FIG. 36 is a diagram view which shows interacting with the assistant interview request manager.

FIG. 37 is a diagram view which shows interacting with the reference network displayer.

FIG. 38 is a diagram view which shows interacting with the assistant past supervisor manager.

FIG. 39 is a diagram view which shows interacting with the supervisor workflow decider.

FIG. 40 is a diagram view which shows interacting with the supervisor eligible type manager.

FIG. 41 is a diagram view which shows interacting with the supervisor network displayer.

FIG. 42 is a diagram view which shows interacting with the supervisor past assistant manager.

### DETAILED DESCRIPTION OF THE INVENTION

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

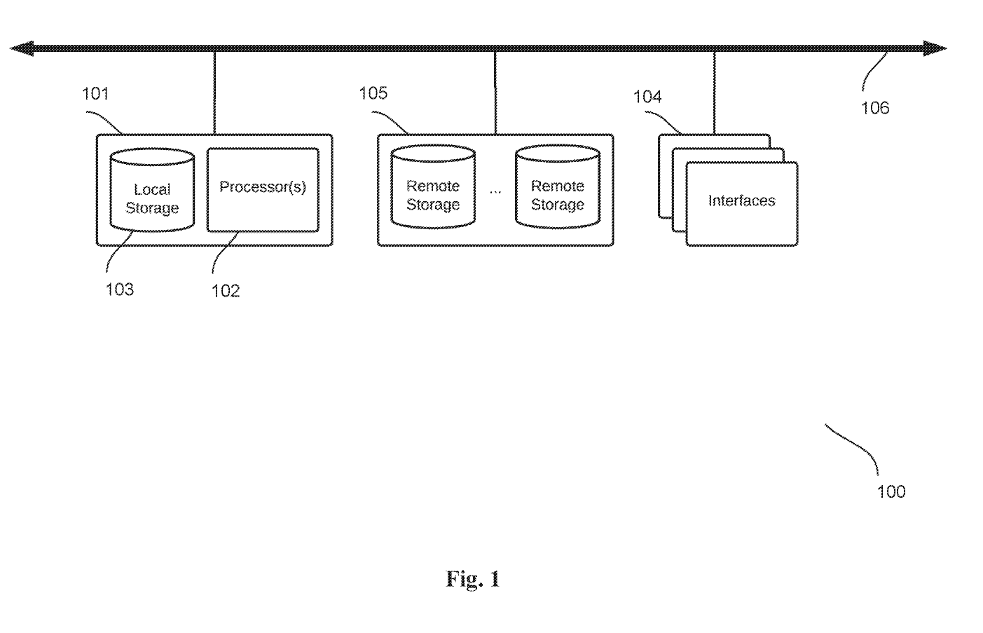

Referring now to FIG. 1, which shows an exemplary hardware architecture of a computing device used in an embodiment of the invention. Computing device 100 (as in FIG. 1) comprises an electronic device capable of executing software- or hardware-based instructions according to one or more programs stored in memory. In some embodiments, examples of computing device 100 may include: desktop computers, carputers, game consoles, laptops, notebooks, a palmtop, a tablet, smartphones, smart books, or a server system utilizing CPU, local memory and/or remote memory, and interface(s). In some embodiments, computing device 100 serves to communicate with a plurality of other computing devices, such as clients or servers, over communications networks. Computing device 100 preferably comprises one or more CPU 101, one or more interface 104, one or more NIC, one or more busses, one or more memory 200, one or more nonvolatile memory 400, one or more storage devices 201, one or more input devices 202, one or more input output units 403, one or more operating systems 203, one or more output devices 204, one or more real time clock 404, and one or more power supply 405. CPU 101 (as in FIG. 1) comprises a unit responsible for implementing specific functions associated with the functions of a specifically configured computing device or machine. In some embodiments, examples of CPU 101 may include: a system-on-a-chip (SOC) type hardware, a Qualcomm SNAPDRAGON™, or a Samsung EXYNOS™ CPU. In some embodiments, CPU 101 serves to perform one or more of the different types of functions and/or operations under the control of software modules or components, which for example, may include an operating system and any appropriate applications software, drivers, and the like. In yet other embodiments, CPU 101 may also serve to run software that carry out one or more functions or applications of embodiments of the invention. Additionally, in other embodiments, CPU 101 serves to carry out computing instructions under control of an operating system. CPU 101 preferably comprises one or more processor 102 and one or more local memory 103. In some embodiments, examples of processor 102 may include: an Intel processor, an ARM processor, a Qualcomm processor, an AMD processor, application-specific integrated circuits (ASICs), electrically erasable programmable read-only memories (EEPROMs), field-programmable gate arrays (FPGAs), a mobile processor, a microprocessor, a microcontroller, a microcomputer, a programmable logic controller, or a programmable circuit.

Local memory 103 (as in FIG. 1) comprises one or more physical devices used to store programs (sequences of instructions) or data (e.g. program state information) on a temporary or permanent basis for use in a computer or other digital electronic device, which may be configured to couple to the system in many different configurations. In some embodiments, examples of local memory 103 may include: non-volatile random-access memory (RAM), read-only memory (ROM), or one or more levels of cached memory. In some embodiments, local memory 103 serves to cache and/or store data. In other embodiments, local memory 103 may also serve to store programming instructions. Interface 104 (as in FIG. 1) comprises a mechanism to control the sending and receiving of data packets over a computer network or support peripherals used with computing device 100. In some embodiments, examples of interface 104 may include: network interface cards (NICs), Ethernet interfaces, frame relay interfaces, cable interfaces, DSL interfaces, token ring interfaces, graphics interfaces, universal serial bus (USB) interfaces, Serial port interfaces, Ethernet interfaces, FIREWIRE™ interfaces, THUNDERBOLT™ interfaces, PCI interfaces, parallel interfaces, radio frequency (RF) interfaces, BLUETOOTH™ interfaces, near-field communications interfaces, 802.11 (WiFi) interfaces, frame relay interfaces, TCP/IP interfaces, ISDN interfaces, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, or fiber data distributed interfaces (FDDIs). Interface 104 preferably comprises one or more physical ports, one or more independent processor, and one or more interface memory. Communications network 106 (as in FIG. 1) comprises a communications network that allows computers to exchange data using known protocols. In some embodiments, examples of communications network 106 may include: a personal area network, a wireless personal area network, a near-me area network, a local area network, a wireless local area network, a wireless mesh network, a wireless metropolitan area network, a wireless wide area network, a cellular network, a home area network, a storage area network, a campus area network, a backbone area network, a metropolitan area network, a wide area network, an enterprise private network, a virtual private network, an intranet, an extranet, an Internetwork, an Internet, near field communications, a mobile telephone network, a CDMA network, GSM cellular networks, or a WiFi network. Remote memory 105 (as in FIG. 1) comprises a service that provides users with a system for the backup, storage, and recovery of data.

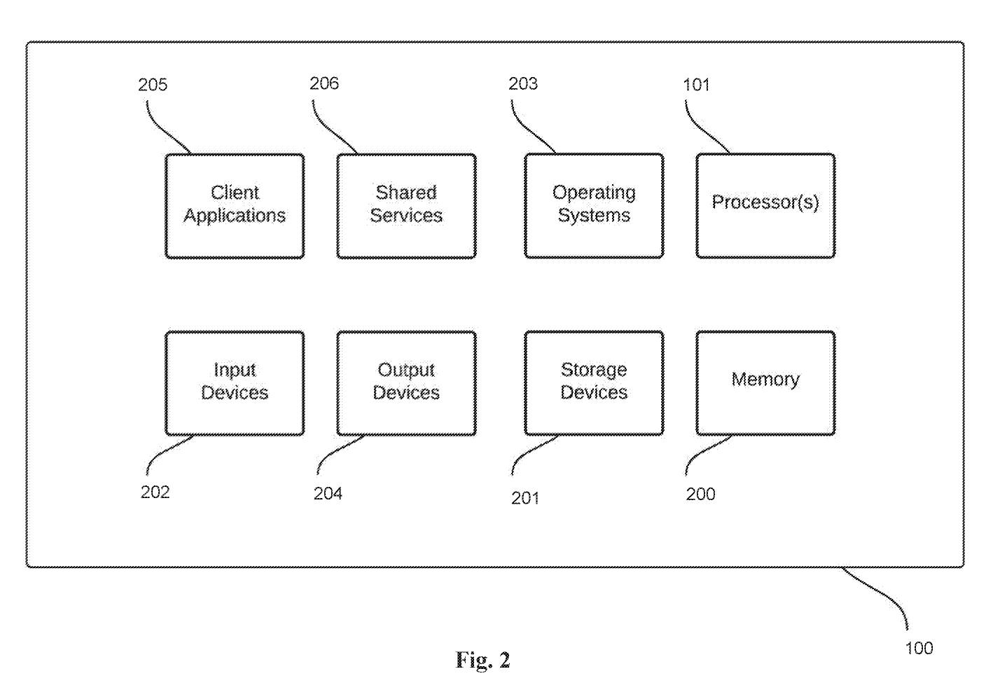

Referring now to FIG. 2, which shows an exemplary logical architecture for a client device, according to an embodiment of the invention. Memory 200 (as in FIG. 2) comprises mechanism designed to store program instructions, state information, and the like for performing various operations described herein, may be storage devices 201, in some embodiments. In some embodiments, examples of memory 200 may include: read-only memory (ROM), read-only memory devices (ROM), a memristor memory, random access memory (RAM), or RAM hardware modules. In some embodiments, memory 200 serves to cache and/or store data. In yet other embodiments, memory 200 may also serve to store program instructions. In yet other embodiments, memory 200 may also serve to store program instructions for the general-purpose network operations. In yet other embodiments, memory 200 may also serve to store information relating to the functionality of the system. In yet other embodiments, memory 200 may also serve to store data structures. In yet other embodiments, memory 200 may also serve to store configuration data. In yet other embodiments, memory 200 may also serve to store encryption data. In yet other embodiments, memory 200 may also serve to store historical system operations information. Additionally, in other embodiments, memory 200 may serve to store non-program information. Operating systems 203 (as in FIG. 2) comprises system software that manages computer hardware and software resources and provides common services for computer programs. In some embodiments, examples of operating systems 203 may include: Microsoft's WINDOWS™, Apple's Mac OS/X, iOS operating systems, a Linux operating system, or Google's ANDROID™ operating system. Input devices 202 (as in FIG. 2) comprises device of any type suitable for receiving user input. Input devices 202 preferably comprises one or more keyboard 401, one or more touchscreen, one or more microphone, mouse 402, a touchpad, and a trackball.

Output devices 204 (as in FIG. 2) comprises device of any type suitable for outputting computing device 100 related information. In some embodiments, examples of output devices 204 may include: screens for visual output, speakers, or printers. Storage devices 201 (as in FIG. 2) comprises mechanism designed to store information which in some embodiments may be memory 200. In some embodiments, examples of storage devices 201 may include: magnetic media, hard disks, floppy disks, a magnetic tape, optical media, CD-ROM disks, magneto-optical media, optical disks, a flash memory, solid state drives (SSD), “hybrid SSD” storage drives, swappable flash memory modules, thumb drives, hot-swappable hard disk drives, solid state drives, removable optical storage discs, or an electrical storage device. Shared services 206 (as in FIG. 2) comprises web-enabled services or functionality related to computing device 100.

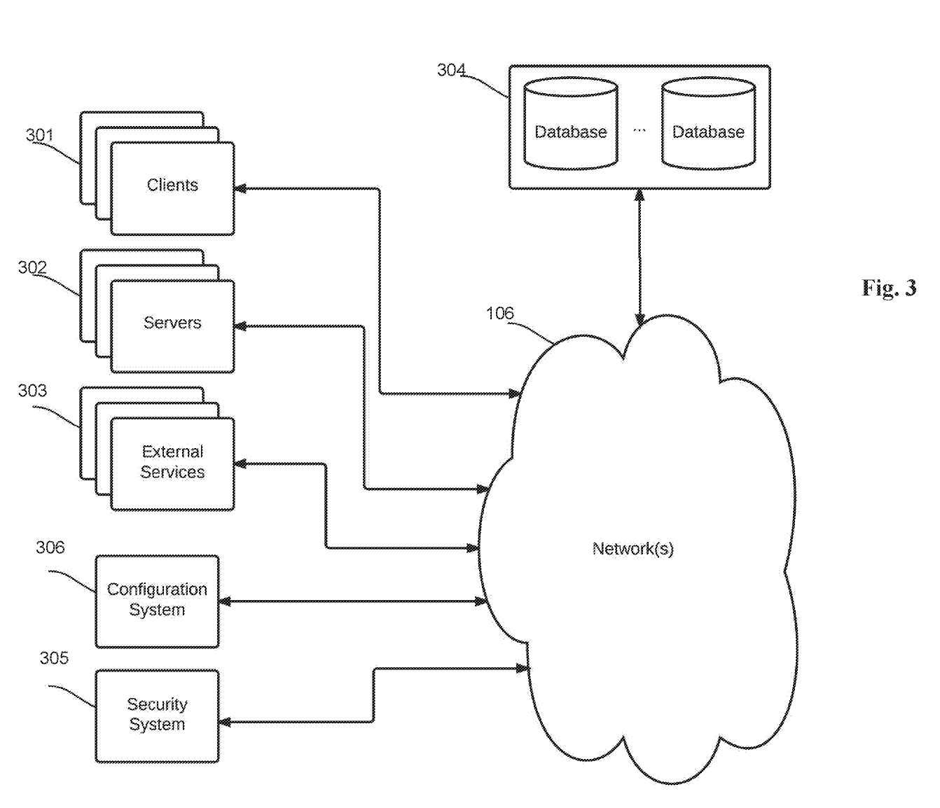

Referring now to FIG. 3, which shows an exemplary architectural arrangement of clients, servers, and external services, according to an embodiment of the invention. Client 301 (as in FIG. 3) comprises one or more computing device 100 with program instructions for implementing client-side portions of the present system which in some embodiments, may be connected to communications network 106.

Server 302 (as in FIG. 3) comprises computing device 100 configured to handle requests received from one or more client 301 over communications network 106. In some embodiments, server 302 serves to call one or more external services 303 when needed to obtain additional information, or to refer to additional data concerning a particular call. External service 303 (as in FIG. 3) comprises web-enabled services or functionality related to or installed on computing device 100 itself which may be deployed on one or more of a particular enterprise's or user's premises.

Security system 305 (as in FIG. 3) comprises a system common to information technology (IT) and web functions that implements security related functions for the system. Configuration system 306 (as in FIG. 3) comprises a system common to information technology (IT) and web functions that implements configurations or management system. Database 304 (as in FIG. 3) comprises an organized collection of data within a programs instruction related system, designed to allow the definition, creation, querying, update, and administration of databases. In some embodiments, examples of database 304 may include: a relational database system, a NoSQL system, a Hadoop system, a Cassandra system, a Google Big Table, column-oriented databases, in-memory databases, or clustered databases. Distributed computing network 300 (as in FIG. 3) comprises any number of client 301 and/or server 302 operably connected to communications network 106 for the purposes of implementing the system. Distributed computing network 300 preferably comprises one or more client application 205, one or more client 301, one or more server 302, one or more external service 303, one or more shared services 206, one or more database 304, one or more security system 305, and configuration system 306.

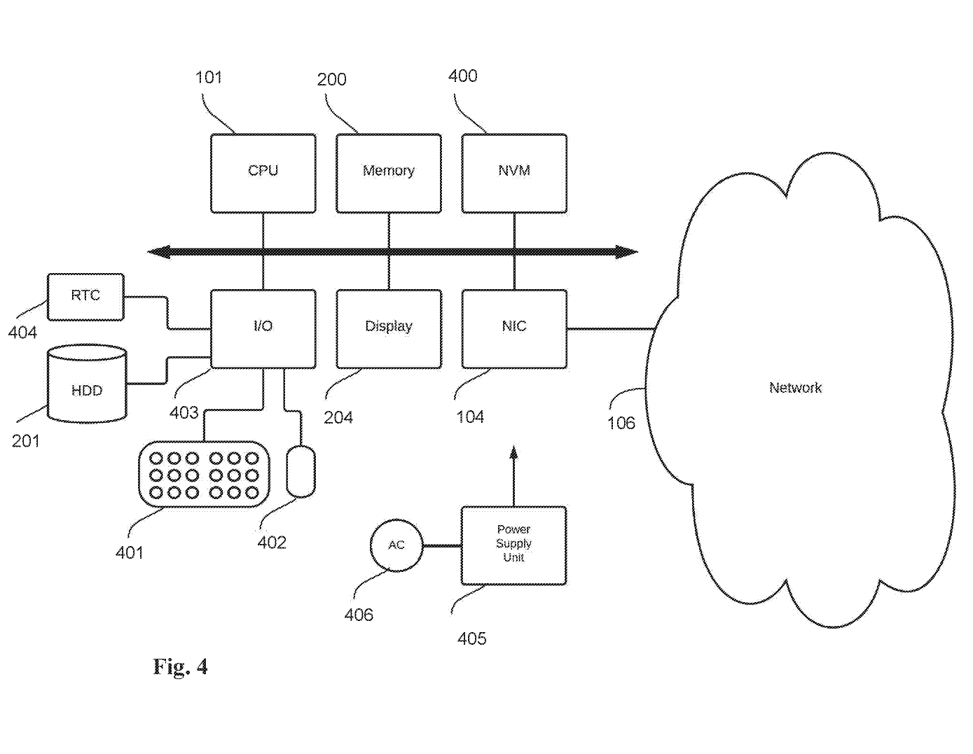

Referring now to FIG. 4, which shows an embodiment of a hardware architecture of a computing device used in various embodiments of the invention. Nonvolatile memory 400 (as in FIG. 4) comprises computer memory 200 that can retrieve stored information even after having been power cycled (turned off and back on). Real time clock 404 (as in FIG. 4) comprises a computer device clock (most often in the form of an integrated circuit) that keeps track of the current time. Input output units 403 (as in FIG. 4) comprises devices used by a human (or other system) to communicate with a computer.

Power supply 405 (as in FIG. 4) comprises an electronic device that supplies electric energy to an electrical load. Power supply 405 preferably comprises one or more power source 406. In some embodiments, an example of power source 406 may be an AC power or a DC power and the like.

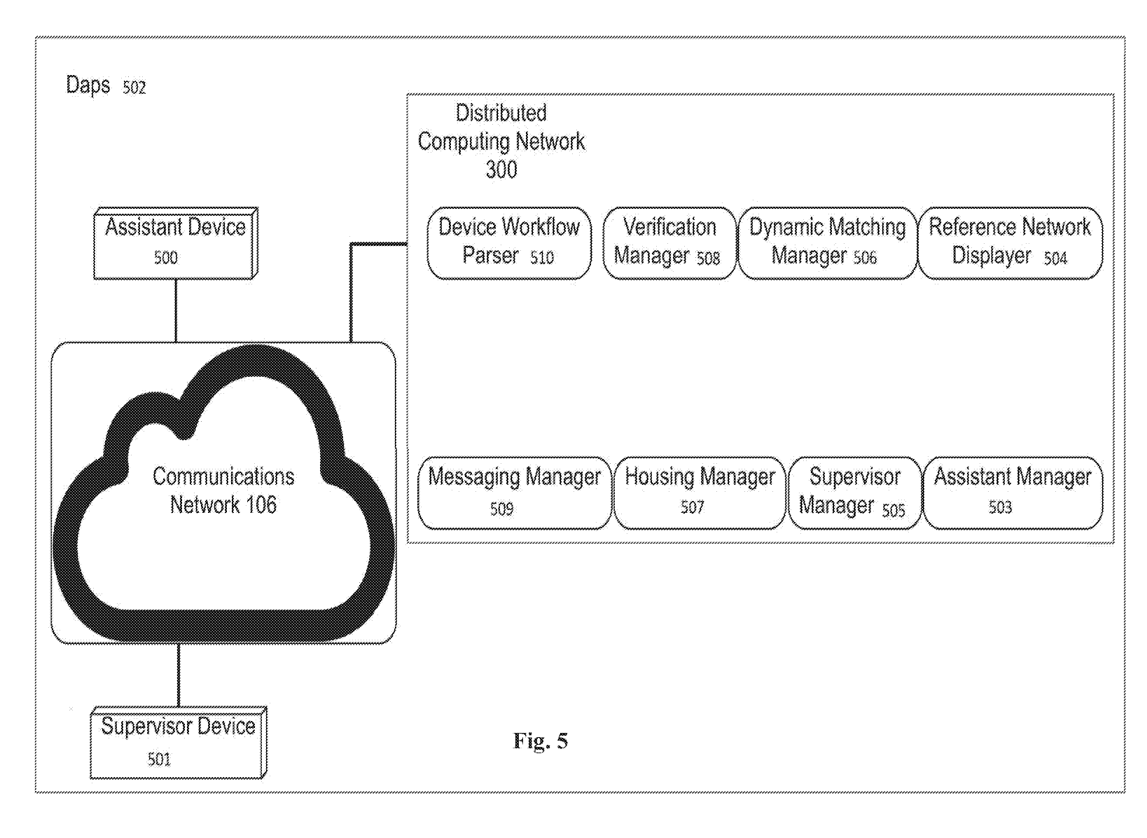

Referring now to FIG. 5 which shows the relationships of a dynamic assistant prediction system (DAPS), its submodules and network connections to devices. DAPS 502 (as in FIG. 5) comprises a system, via a dynamic assistant prediction computer 502, that allows dual filtering for matching queries for assistant device 500 and/or supervisor device 501 for implementing a work arrangement. Daps 502 preferably comprises assistant manager 503, reference network displayer 504, supervisor manager 505, dynamic matching manager 506, housing manager 507, verification manager 508, messaging manager 509, and device workflow parser 510. Assistant manager 503 (as in FIG. 5) comprises a module that manages the interactions, storage, display and processing of related functions of assistant device 500. Assistant manager 503 preferably comprises assistant registrar 2000, assistant past supervisor manager 2002, assistant workflow decider 2005, assistant profile manager 2006, and assistant interview request manager 2007. Reference network displayer 504 (as in FIG. 5) comprises a module that manages the interactions, storage, display and processing of the assistant reference network related functions of computing device 100. Reference network displayer 504 preferably comprises existing reference network displayer 2100, pending reference network displayer 2101, and request multi reference network displayer 2102.

Supervisor manager 505 (as in FIG. 5) comprises a module that manages the interactions, storage, display and processing of related functions of supervisor device 501. Supervisor manager 505 preferably comprises supervisor registrar 2200, a supervisor past assistant manager 503, supervisor profile manager 2403, supervisor workflow decider 2404, supervisor multi-assistant displayer 2300, supervisor search submitter 2405, supervisor assistant interview request manager 2406, and supervisor eligible type manager 2407. Dynamic matching manager 506 (as in FIG. 5) comprises a module that receives data from supervisor devices and assistant devices and which implements algorithms in order to increase the likelihood of matching supervisors and assistants. Dynamic matching manager 506 preferably comprises ethos processor 2500, ethos algorithm processor 2503, category matching processor 2504, and dynamic matching algorithm processor 2510.

Housing manager 507 (as in FIG. 5) comprises a module that manages the interaction between assistant devices 500 and supervisor devices 501 and coordinate housing arrangements for a putative working relationship.

Verification manager 508 (as in FIG. 5) comprises a module that manages establishing the validity of the corroboration between instances of putative assistant data and putative supervisor data. In some embodiments, verification manager 508 may include: length of time worked data, name data, description of work data, supervisor company name data, or supervisor company title data. Messaging manager 509 (as in FIG. 5) comprises a module that manages the interaction between assistant devices 500 and supervisor devices 501, where the assistant devices 500 may message other assistant devices 500, but not supervisor devices 501, and the supervisor devices 501 may message both assistant devices 500 and supervisor devices 501. Device workflow parser 510 (as in FIG. 5) comprises a module that allows the designation of the role of the user for continued use of the system.

Supervisor device 501 (as in FIG. 5) comprises computing device 100 that may be used by a supervisor to interact with the DAPS system. Assistant device 500 (as in FIG. 5) comprises computing device 100 that may be used by an assistant to interact with the DAPS system.

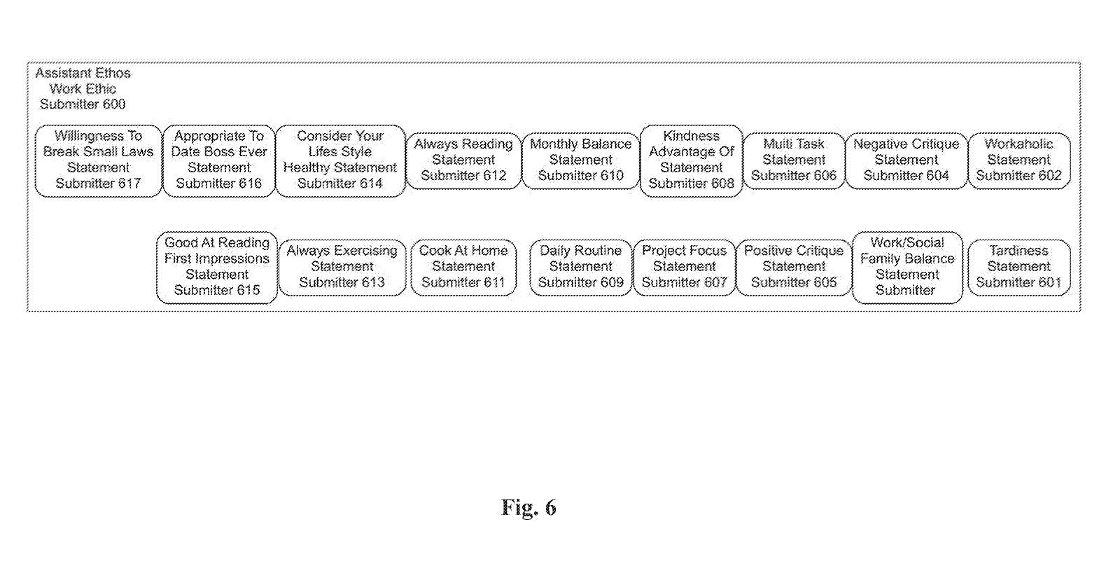

Referring now to FIG. 6 which displays the relationships between the assistant ethos work ethic submitter module and its submodules. Tardiness statement submitter 601 (as in FIG. 6) comprises a module that accepts scalar data (in some embodiments, input through a slider interface) regarding the self-perception of the overall tardiness of the assistant as reflected in agreeing with a prompting statement. For example, a prompting statement present on the assistant device might be: “I feel that tardiness is acceptable most of the time.” Workaholic statement submitter 602 (as in FIG. 6) comprises a module that accepts scalar data (in some embodiments, input through a slider interface) regarding the self-perception of the overall workaholic nature of the assistant as reflected in agreeing with a prompting statement. For example, a prompting statement present on the assistant device might be: “I am a workaholic.” Work/social/family balance statement submitter 603 (as in FIG. 6) comprises a module that accepts scalar data (in some embodiments, input through a slider interface) regarding the self-perception of the overall work/social family balance beliefs of the assistant as reflected in agreeing with a prompting statement. For example, a prompting statement present on the assistant device may be “Work/social/family balance is important to maintain.”

Negative critique statement submitter 604 (as in FIG. 6) comprises a module that accepts scalar data (in some embodiments, input through a slider interface) regarding the self-perception of the overall reaction of a negative critique of the assistant as reflected in agreeing with a prompting statement. For example, a prompting statement present on the assistant device might be: “I prefer for people to directly address my shortcomings.” Positive critique statement submitter 605 (as in FIG. 6) comprises a module that accepts scalar data (in some embodiments, input through a slider interface) regarding the self-perception of the overall reaction of a positive critique of the assistant as reflected in agreeing with a prompting statement. For example, a prompting statement present on the assistant device might be: “I highly value positive reinforcement.” Multi-task statement submitter 606 (as in FIG. 6) comprises a module that accepts scalar data (in some embodiments, input through a slider interface) regarding the self-perception of the overall multi-tasking ability of the assistant as reflected in agreeing with a prompting statement. For example, a prompting statement present on the assistant device may be “Multi-tasking comes easily to me.”

Project focus statement submitter 607 (as in FIG. 6) comprises a module that accepts scalar data (in some embodiments, input through a slider interface) regarding the self-perception of the overall importance for project focus for the assistant as reflected in agreeing with a prompting statement. For example, a prompting statement present on the assistant device might be: “I have the ability to focus on the completion of one task at a time.” Kindness advantage of statement submitter 608 (as in FIG. 6) comprises a module that accepts scalar data (in some embodiments, input through a slider interface) regarding the self-perception of the overall importance of kindness to the assistant as reflected in agreeing with a prompting statement. For example, a prompting statement present on the assistant device may be: “I feel that it is important to be kind even if it means being walked on.” Daily routine statement submitter 609 (as in FIG. 6) comprises a module that accepts scalar data (in some embodiments, input through a slider interface) regarding the self-perception of the overall importance of daily routine to the assistant as reflected in agreeing with a prompting statement. For example, a prompting statement present on the assistant device may be: “I feel that a daily routine is important.”

Monthly balance statement submitter 610 (as in FIG. 6) comprises a module that accepts scalar data (in some embodiments, input through a slider interface) regarding the self-perception of the overall importance of monthly balance of the assistant as reflected in agreeing with a prompting statement. For example, a prompting statement present on the assistant device may be: “I feel that having monthly balance is important.” Cook at home statement submitter 611 (as in FIG. 6) comprises a module that accepts scalar data (in some embodiments, input through a slider interface) regarding the self-perception of the importance of cooking at home to the assistant as reflected in agreeing with a prompting statement. For example, a prompting statement present on the assistant device may be: “I cook at home as often as I can.” Always reading statement submitter 612 (as in FIG. 6) comprises a module that accepts scalar data (in some embodiments, input through a slider interface) regarding the self-perception of how important regular reading is to the assistant as reflected in agreeing with a prompting statement. For example, a prompting statement present on the assistant device may be: “I feel that I am always reading.”

Always exercising statement submitter 613 (as in FIG. 6) comprises a module that accepts scalar data (in some embodiments, input through a slider interface) regarding the self-perception of the importance of exercise to the assistant as reflected in agreeing with a prompting statement. For example, a prompting statement present on the assistant device may be: “I am always exercising.” Consider your lifestyle healthy statement submitter 614 (as in FIG. 6) comprises a module that accepts scalar data (in some embodiments, input through a slider interface) regarding the self-perception of the importance of a healthy lifestyle to the assistant as reflected in agreeing with a prompting statement. For example, a prompting statement present on the assistant device may be: “I feel that I have a healthy lifestyle.” Good at reading first impressions statement submitter 615 (as in FIG. 6) comprises a module that accepts scalar data (in some embodiments, input through a slider interface) regarding the self-perception of the reading skills of the assistant as reflected in agreeing with a prompting statement.

For example, a prompting statement present on the assistant device, may be: “I feel that first impressions are important.” Appropriate to date supervisor ever statement submitter 616 (as in FIG. 6) comprises a module that accepts scalar data (in some embodiments, input through a slider interface) regarding the self-perception of the value of the appropriateness of dating a supervisor of the assistant as reflected in agreeing with a prompting statement. For example, a prompting statement present on the assistant device may be: “On occasion it is ok that an assistant and supervisor become romantically involved.” Willingness to break small laws statement submitter 617 (as in FIG. 6) comprises a module that accepts scalar data (in some embodiments, input through a slider interface) regarding the self-perception of the value of always adhering strictly to the law to the assistant as reflected in agreeing with a prompting statement. For example, a prompting statement present on the assistant device may be: “If asked by an employer, on occasion it is ok to break a law if it doesn't hurt anybody.” Assistant ethos work ethic submitter 600 (as in FIG. 6) comprises a module that collectively manages the display and submission of different sub characteristics of work ethic data for assistants. Assistant ethos work ethic submitter 600 preferably comprises tardiness statement submitter 601, workaholic statement submitter 602, work/social/family balance statement submitter 603, negative critique statement submitter 604, positive critique statement submitter 605, multi-task statement submitter 606, project focus statement submitter 607, kindness advantage of statement submitter 608, daily routine statement submitter 609, monthly balance statement submitter 610, cook at home statement submitter 611, always reading statement submitter 612, always exercising statement submitter 613, consider your lifestyle healthy statement submitter 614, good at reading first impressions statement submitter 615, appropriate to date supervisor ever statement submitter 616, and, willingness to break small laws statement submitter 617.

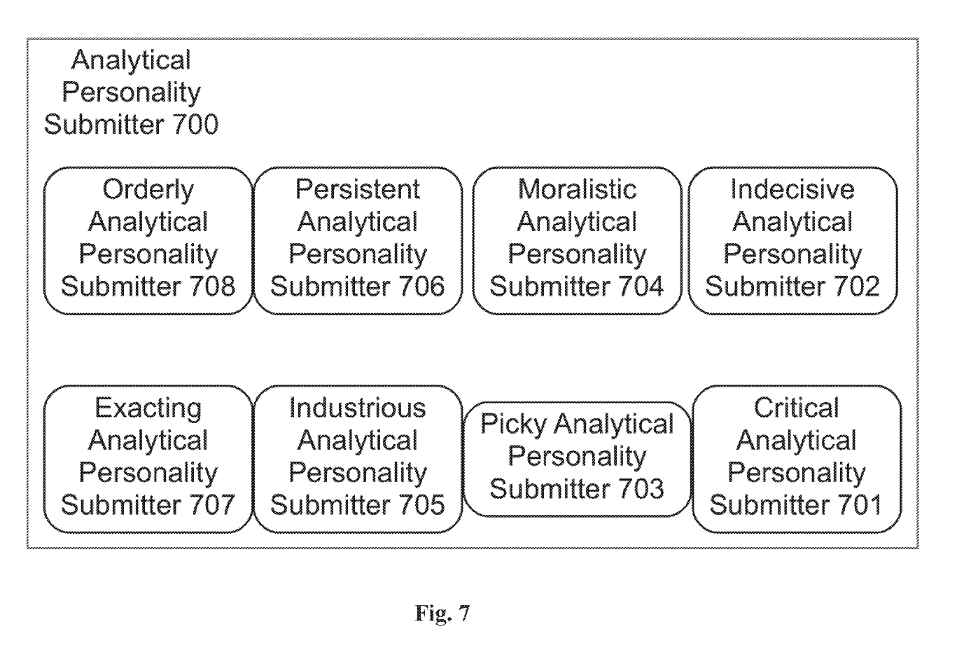

Referring now to FIG. 7 which shows the relationships of the analytical personality submitter module and its submodules. Analytical personality submitter 700 (as in FIG. 7) comprises a module that collectively manages the display and submission of analytical sub types of personality data for assistants. Analytical personality submitter 700 preferably comprises critical analytical personality submitter 701, indecisive analytical personality submitter 702, picky analytical personality submitter 703, moralistic analytical personality submitter 704, industrious analytical personality submitter 705, persistent analytical personality submitter 706, exacting analytical personality submitter 707, and orderly analytical personality submitter 708. Critical analytical personality submitter 701 (as in FIG. 7) comprises a module that accepts scalar data (in some embodiments, input through a slider interface) regarding the self-perception of the overall critical analytical personality characteristics of the assistant. For example, a prompting question present on the assistant device may be: “How important is it to be critical and direct when evaluating a situation?” Indecisive analytical personality submitter 702 (as in FIG. 7) comprises a module that accepts scalar data (in some embodiments, input through a slider interface) regarding the self-perception of the overall indecisive analytical personality characteristics of the assistant. For example, a prompting question present on the assistant device may be: “How indecisive do you consider yourself relative to others?” Picky analytical personality submitter 703 (as in FIG. 7) comprises a module that accepts scalar data (in some embodiments, input through a slider interface) regarding the self-perception of the overall picky analytical personality characteristics of the assistant. For example, a prompting question present on the assistant device may be” “How picky do you consider yourself relative to others?” Moralistic analytical personality submitter 704 (as in FIG. 7) comprises a module that accepts scalar data (in some embodiments, input through a slider interface) regarding the self-perception of the overall moralistic analytical personality submitter 704 characteristics of the assistant. For example, a prompting question present on the assistant device may be: “How moralistic do you consider yourself relative to others?” Industrious analytical personality submitter 705 (as in FIG. 7) comprises a module that accepts scalar data (in some embodiments, input through a slider interface) regarding the self-perception of the overall industrious analytical personality characteristics of the assistant. For example, a prompting question present on the assistant device may be: “How industrious do you consider yourself relative to others?”

Persistent analytical personality submitter 706 (as in FIG. 7) comprises a module that accepts scalar data (in some embodiments, input through a slider interface) regarding the self-perception of the overall persistent analytical personality characteristics of the assistant. For example, a prompting question present on the assistant device may be: “How persistent do you consider yourself relative to others?” Exacting analytical personality submitter 707 (as in FIG. 7) comprises a module that accepts scalar data (in some embodiments, input through a slider interface) regarding the self-perception of the overall exacting analytical personality characteristics of the assistant. For example, a prompting question present on the assistant device may be: “How important is it to be exact when detailing or dealing with a situation?” Orderly analytical personality submitter 708 (as in FIG. 7) comprises a module that accepts scalar data (in some embodiments, input through a slider interface) regarding the self-perception of the overall orderly analytical personality characteristics of the assistant. For example, a prompting question present on the assistant device may be: “How orderly do you consider yourself relative to others?”

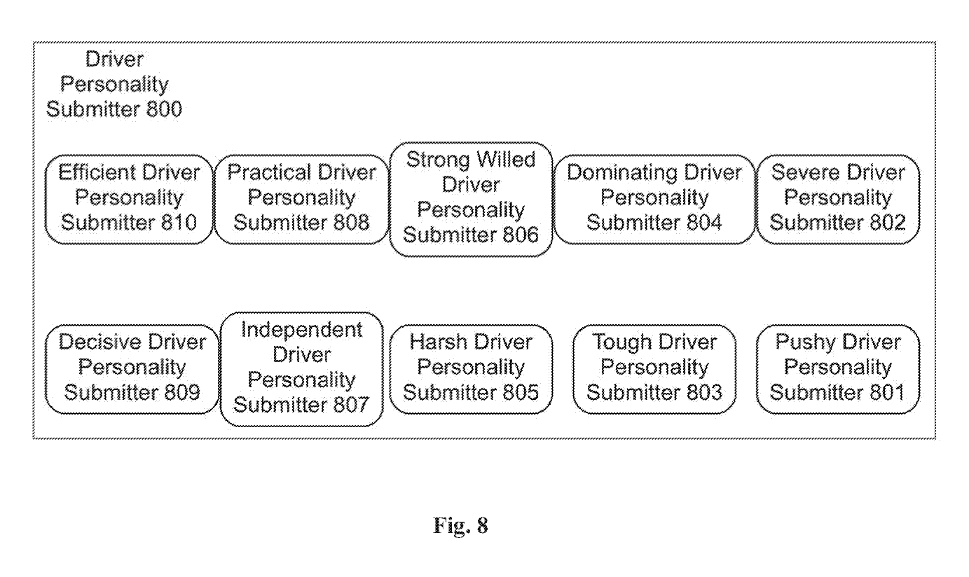

Referring now to FIG. 8 are relationships of the driver personality submitter module and its submodules. Driver personality submitter 800 (as in FIG. 8) comprises a module that collectively manages the display and submission of driver sub types of personality data for assistants. Driver personality submitter 800 preferably comprises pushy driver personality submitter 801, severe driver personality submitter 802, tough driver personality submitter 803, dominating driver personality submitter 804, harsh driver personality submitter 805, strong-willed driver personality submitter 806, independent driver personality submitter 807, practical driver personality submitter 808, decisive driver personality submitter 809, and efficient driver personality submitter 810. Pushy driver personality submitter 801 (as in FIG. 8) comprises a module that accepts scalar data (in some embodiments, input through a slider interface) regarding the self-perception of the overall pushy driver personality characteristics of the assistant. For example, a prompting question present on the assistant device may be: “How pushy do you consider yourself relative to others?” Severe driver personality submitter 802 (as in FIG. 8) comprises a module that accepts scalar data (in some embodiments, input through a slider interface) regarding the self-perception of the overall severe driver personality characteristics of the assistant. For example, a prompting question present on the assistant device may be: “How important is it to be severe (blunt) in a given situation?”

Tough driver personality submitter 803 (as in FIG. 8) comprises a module that accepts scalar data (in some embodiments, input through a slider interface) regarding the self-perception of the overall tough driver personality characteristics of the assistant. For example, a prompting question present on the assistant device may be: “How tough do you consider yourself relative to others?” Dominating driver personality submitter 804 (as in FIG. 8) comprises a module that accepts scalar data (in some embodiments, input through a slider interface) regarding the self-perception of the overall dominating driver personality characteristics of the assistant. For example, a prompting question present on the assistant device may be: “How dominating do you consider yourself relative to others?” Harsh driver personality submitter 805 (as in FIG. 8) comprises a module that accepts scalar data (in some embodiments, input through a slider interface) regarding the self-perception of the overall harsh driver personality characteristics of the assistant. For example, a prompting question present on the assistant device may be: “How harsh do you consider yourself relative to others?”

Strong-willed driver personality submitter 806 (as in FIG. 8) comprises a module that accepts scalar data (in some embodiments, input through a slider interface) regarding the self-perception of the overall strong-willed driver personality characteristics of the assistant. For example, a prompting question present on the assistant device may be: “How strong willed do you consider yourself relative to others?” Independent driver personality submitter 807 (as in FIG. 8) comprises a module that accepts scalar data (in some embodiments, input through a slider interface) regarding the self-perception of the overall independent driver personality characteristics of the assistant. For example, a prompting question present on the assistant device may be: “How independent do you consider yourself relative to others?” Practical driver personality submitter 808 (as in FIG. 8) comprises a module that accepts scalar data (in some embodiments, input through a slider interface) regarding the self-perception of the overall practical driver personality characteristics of the assistant. For example, a prompting question present on the assistant device may be: “How practical do you consider yourself relative to others?” Decisive driver personality submitter 809 (as in FIG. 8) comprises a module that accepts scalar data (in some embodiments, input through a slider interface) regarding the self-perception of the overall decisive driver personality characteristics of the assistant. For example, a prompting question present on the assistant device may be: “How decisive do you consider yourself relative to others?” Efficient driver personality submitter 810 (as in FIG. 8) comprises a module that accepts scalar data (in some embodiments, input through a slider interface) regarding the self-perception of the overall efficient driver personality characteristics of the assistant. For example, a prompting question present on the assistant device may be: “How efficient do you consider yourself relative to others?”

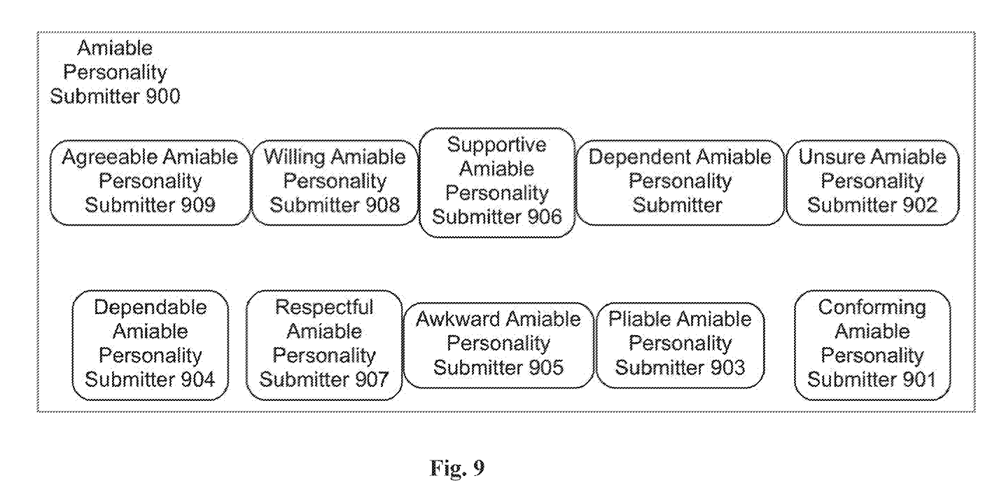

Referring now to FIG. 9 are relationships of the amiable personality submitter module and its submodules. Amiable personality submitter 900 (as in FIG. 9) comprises a module that collectively manages the display and submission of amiable sub types of personality data for assistants. Amiable personality submitter 900 preferably comprises conforming amiable personality submitter 901, unsure amiable personality submitter 902, pliable amiable personality submitter 903, dependable amiable personality submitter 904, awkward amiable personality submitter 905, supportive amiable personality submitter 906, respectful amiable personality submitter 907, willing amiable personality submitter 908, dependable amiable personality submitter 904, and agreeable amiable personality submitter 909. Conforming amiable personality submitter 901 (as in FIG. 9) comprises a module that accepts scalar data (in some embodiments, input through a slider interface) regarding the self-perception of the conforming amiable personality characteristics of the assistant. For example, a prompting question present on the assistant device may be: “How conforming (accommodating) do you consider yourself to others?” Unsure amiable personality submitter 902 (as in FIG. 9) comprises a module that accepts scalar data (in some embodiments, input through a slider interface) regarding the self-perception of the unsure amiable personality characteristics of the assistant. For example, a prompting question present on the assistant device may be: “How unsure do you consider yourself relative to others?”

Pliable amiable personality submitter 903 (as in FIG. 9) comprises a module that accepts scalar data (in some embodiments, input through a slider interface) regarding the self-perception of the pliable amiable personality characteristics of the assistant. For example, a prompting question present on the assistant device may be: “How pliable do you consider yourself relative to others?” Dependable amiable personality submitter 904 (as in FIG. 9) comprises a module that accepts scalar data (in some embodiments, input through a slider interface) regarding the self-perception of the dependent amiable personality characteristics of the assistant. For example, a prompting question present on the assistant device may be: “How dependable do you consider yourself relative to others?” Awkward amiable personality submitter 905 (as in FIG. 9) comprises a module that accepts scalar data (in some embodiments, input through a slider interface) regarding the self-perception of the awkward amiable personality characteristics of the assistant. For example, a prompting question present on the assistant device may be: “How awkward do you consider yourself relative to others?”

Supportive amiable personality submitter 906 (as in FIG. 9) comprises a module that accepts scalar data (in some embodiments, input through a slider interface) regarding the self-perception of the supportive amiable personality characteristics of the assistant. For example, a prompting question present on the assistant device may be: “How supportive do you consider yourself relative to others?” Respectful amiable personality submitter 907 (as in FIG. 9) comprises a module that accepts scalar data (in some embodiments, input through a slider interface) regarding the self-perception of the respectful amiable personality characteristics of the assistant. For example, a prompting question present on the assistant device may be: “How respectful do you consider yourself relative to others?” Willing amiable personality submitter 908 (as in FIG. 9) comprises a module that accepts scalar data (in some embodiments, input through a slider interface) regarding the self-perception of the willing amiable personality characteristics of the assistant. For example, a prompting question present on the assistant device may be: “How moldable do you consider yourself relative to others?” Agreeable amiable personality submitter 909 (as in FIG. 9) comprises a module that accepts scalar data (in some embodiments, input through a slider interface) regarding the self-perception of the agreeable amiable personality characteristics of the assistant. For example, a prompting question present on the assistant device may be: “How agreeable do you consider yourself relative to others?”

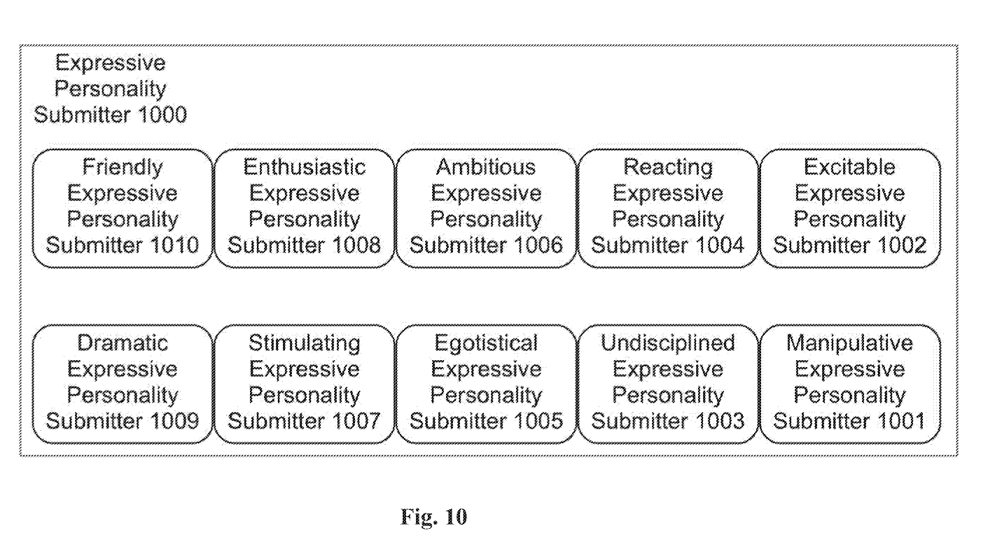

Referring now to FIG. 10 are relationships of the expressive personality submitter module and its submodules. Expressive personality submitter 1000 (as in FIG. 10) comprises a module that collectively manages the display and submission of expressive sub types of personality data for assistants. Expressive personality submitter 1000 preferably comprises manipulative expressive personality submitter 1001, excitable expressive personality submitter 1002, undisciplined expressive personality submitter 1003, reacting expressive personality submitter 1004, egotistical expressive personality submitter 1005, ambitious expressive personality submitter 1006, stimulating expressive personality submitter 1007, enthusiastic expressive personality submitter 1008, dramatic expressive personality submitter 1009, and friendly expressive personality submitter 1010. Manipulative expressive personality submitter 1001 (as in FIG. 10) comprises a module that accepts scalar data (in some embodiments, input through a slider interface) regarding the self-perception of the manipulative expressive personality characteristics of the assistant. For example, a prompting question present on the assistant device may be: “How manipulative do you consider yourself relative to others?” Excitable expressive personality submitter 1002 (as in FIG. 10) comprises a module that accepts scalar data (in some embodiments, input through a slider interface) regarding the self-perception of the excitable expressive personality characteristics of the assistant. For example, a prompting question present on the assistant device may be: “How excitable do you consider yourself relative to others?”

Undisciplined expressive personality submitter 1003 (as in FIG. 10) comprises a module that accepts scalar data (in some embodiments, input through a slider interface) regarding the self-perception of the undisciplined expressive personality characteristics of the assistant. For example, a prompting question present on the assistant device may be: “How undisciplined do you consider yourself relative to others?” Reacting expressive personality submitter 1004 (as in FIG. 10) comprises a module that accepts scalar data (in some embodiments, input through a slider interface) regarding the self-perception of the reacting expressive personality characteristics of the assistant. For example, a prompting question present on the assistant device may be: “How reactive do you consider yourself relative to others?” Egotistical expressive personality submitter 1005 (as in FIG. 10) comprises a module that accepts scalar data (in some embodiments, input through a slider interface) regarding the self-perception of the egotistical expressive personality characteristics of the assistant. For example, a prompting question present on the assistant device may be: “How egotistical do you consider yourself relative to others?”

Ambitious expressive personality submitter 1006 (as in FIG. 10) comprises a module that accepts scalar data (in some embodiments, input through a slider interface) regarding the self-perception of the ambitious expressive personality characteristics of the assistant. For example, a prompting question present on the assistant device may be: “How ambitious do you consider yourself relative to others?” Stimulating expressive personality submitter 1007 (as in FIG. 10) comprises a module that accepts scalar data (in some embodiments, input through a slider interface) regarding the self-perception of the stimulating expressive personality characteristics of the assistant. For example, a prompting question present on the assistant device may be: “How engaging do you consider yourself relative to others?” Enthusiastic expressive personality submitter 1008 (as in FIG. 10) comprises a module that accepts scalar data (in some embodiments, input through a slider interface) regarding the self-perception of the enthusiastic expressive personality characteristics of the assistant. For example, a prompting question present on the assistant device may be: “How enthusiastic do you consider yourself relative to others?”

Dramatic expressive personality submitter 1009 (as in FIG. 10) comprises a module that accepts scalar data (in some embodiments, input through a slider interface) regarding the self-perception of the dramatic expressive personality characteristics of the assistant. For example, a prompting question present on the assistant device may be: “How dramatic do you consider yourself relative to others?” Friendly expressive personality submitter 1010 (as in FIG. 10) comprises a module that accepts scalar data (in some embodiments, input through a slider interface) regarding the self-perception of the friendly expressive personality characteristics of the assistant. For example, a prompting question present on the assistant device may be: “How friendly do you consider yourself relative to others?”

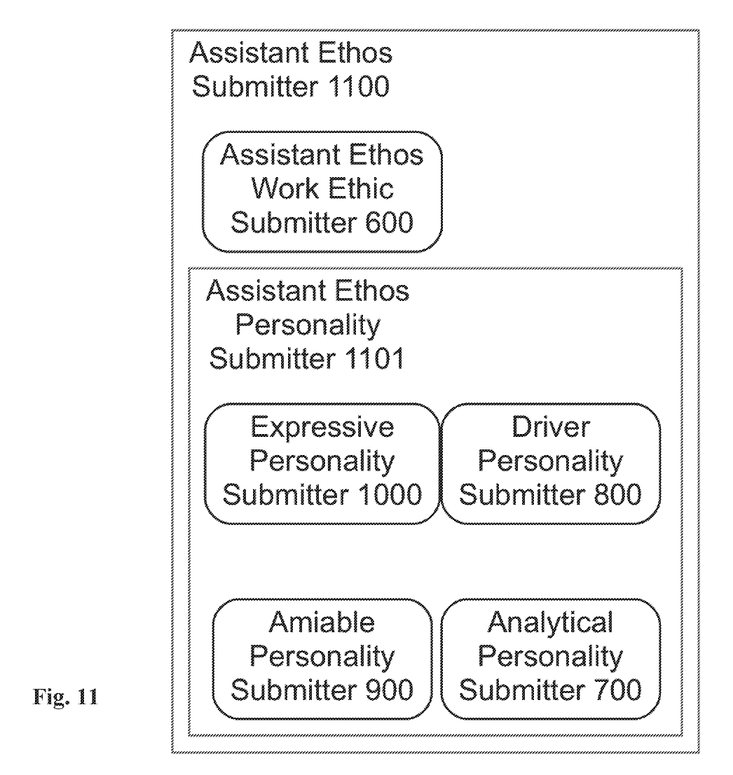

Referring now to FIG. 11 are relationships of the assistant ethos submitter module and its submodules. Assistant ethos submitter 1100 (as in FIG. 11) comprises a module that collectively manages the display and submission of assistant personality data and work ethic data. Assistant ethos submitter 1100 preferably comprises assistant ethos personality submitter 1101 and assistant ethos work ethic submitter 600. Assistant ethos personality submitter 1101 (as in FIG. 11) comprises a module that collectively manages the display and submission of different sub characteristics of personality data for assistants. Assistant ethos personality submitter 1101 preferably comprises analytical personality submitter 700, driver personality submitter 800, amiable personality submitter 900, and expressive personality submitter 1000.

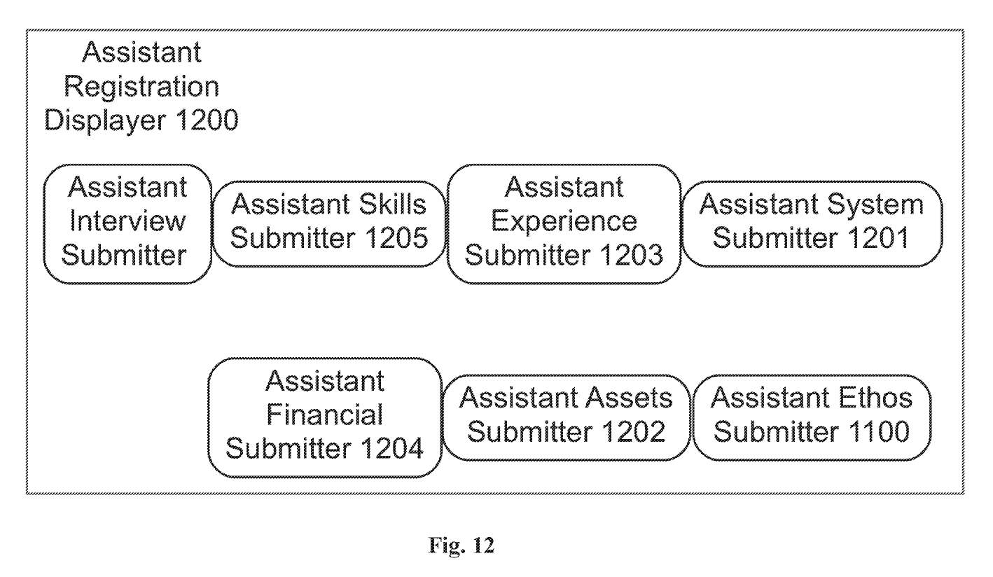

Referring now to FIG. 12 are relationships of the assistant registration displayer module and its submodules. Assistant registration displayer 1200 (as in FIG. 12) comprises a module that displays the assistant registration components in order to accept input for assistant registration object 1900. Assistant registration displayer 1200 preferably comprises assistant ethos submitter 1100, assistant system submitter 1201, assistant assets submitter 1202, assistant experience submitter 1203, assistant financial submitter 1204, and assistant skills submitter 1205. Assistant system submitter 1201 (as in FIG. 12) comprises a module that accepts data relative to an assistant that may be uniquely identifying, such as, but not limited to, name or email. Assistant assets submitter 1202 (as in FIG. 12) comprises a module that accepts data related to the physical or tangible assets that may be important for employment, such as license, etc.

Assistant experience submitter 1203 (as in FIG. 12) comprises a module that accepts data relative to an assistant's experience that may be important for job qualifications. Assistant financial submitter 1204 (as in FIG. 12) comprises a module that accepts data relative to an assistant's financial information that may be important for interacting with the system and/or for job qualifications. Assistant skills submitter 1205 (as in FIG. 12) comprises a module that accepts data relative to an assistant's skills that may be important for job qualifications, such as, but not limited to technical skills or computer skills.

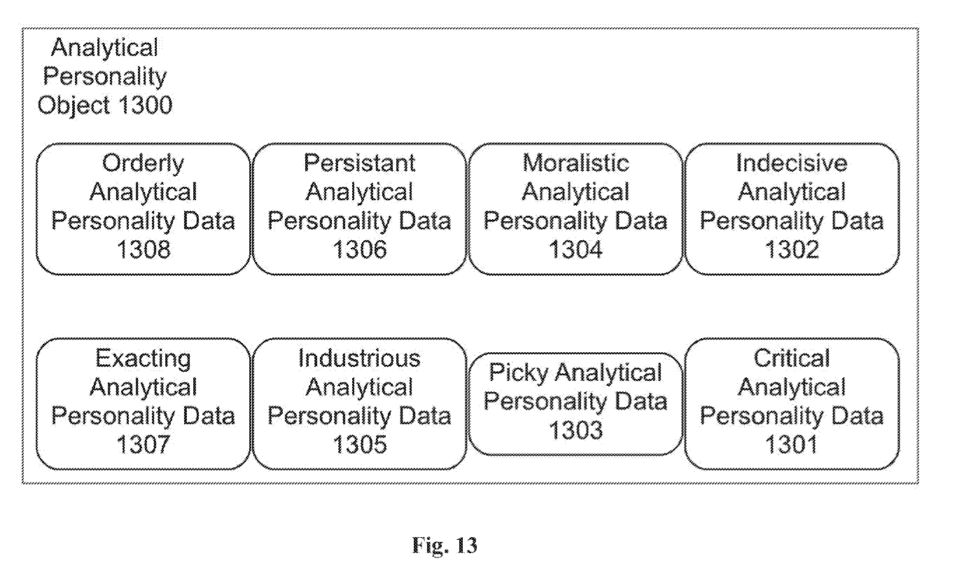

Referring now to FIG. 13 are relationships of the analytical personality object module and its submodules. Analytical personality object 1300 (as in FIG. 13) comprises a data object for analytical characteristics of personality data. Analytical personality object 1300 preferably comprises critical analytical personality data 1301, indecisive analytical personality data 1302, picky analytical personality data 1303, moralistic analytical personality data 1304, industrious analytical personality data 1305, persistent analytical personality data 1306, exacting analytical personality data 1307, and orderly analytical personality data 1308. Critical analytical personality data 1301 (as in FIG. 13) comprises data value, preferably scalar data, regarding the self-perception of the overall critical analytical personality characteristics of the assistant. Input as a result of being prompted on assistant device 500. Indecisive analytical personality data 1302 (as in FIG. 13) comprises data value, preferably scalar data, regarding the self-perception of the overall indecisive analytical personality characteristics of the assistant. Input as a result of being prompted on assistant device 500.

Picky analytical personality data 1303 (as in FIG. 13) comprises data value, preferably scalar data, regarding the self-perception of the overall picky analytical personality characteristics of the assistant. Input as a result of being prompted on assistant device 500. Moralistic analytical personality data 1304 (as in FIG. 13) comprises data value, preferably scalar data, regarding the self-perception of the overall moralistic analytical personality data characteristics of the assistant. Input as a result of being prompted on assistant device 500. Industrious analytical personality data 1305 (as in FIG. 13) comprises data value, preferably scalar data, regarding the self-perception of the overall industrious analytical personality characteristics of the assistant. Input as a result of being prompted on assistant device 500.

Persistent analytical personality data 1306 (as in FIG. 13) comprises data value, preferably scalar data, regarding the self-perception of the overall persistent analytical personality characteristics of the assistant. Input as a result of being prompted on assistant device 500. Exacting analytical personality data 1307 (as in FIG. 13) comprises data value, preferably scalar data, regarding the self-perception of the overall exacting analytical personality characteristics of the assistant. Input as a result of being prompted on assistant device 500. Orderly analytical personality data 1308 (as in FIG. 13) comprises data value, preferably scalar data, regarding the self-perception of the overall orderly analytical personality characteristics of the assistant. Input as a result of being prompted on assistant device 500.

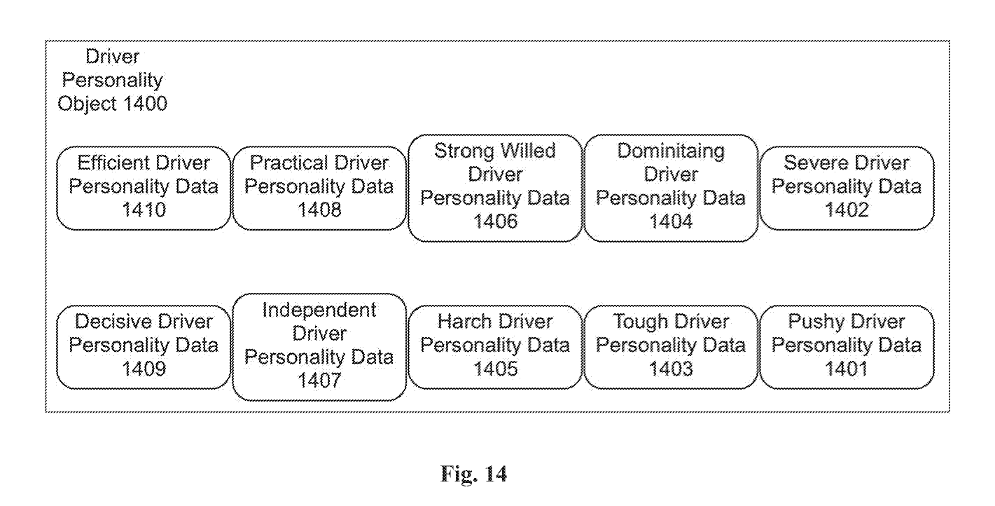

Referring now to FIG. 14 are relationships of the driver personality object module and its submodules. Driver personality object 1400 (as in FIG. 14) comprises a data object for driver characteristics of personality data. Driver personality object 1400 preferably comprises pushy driver personality data 1401, severe driver personality data 1402, tough driver personality data 1403, dominating driver personality data 1404, harsh driver personality data 1405, strong-willed driver personality data 1406, independent driver personality data 1407, practical driver personality data 1408, decisive driver personality data 1409, and efficient driver personality data 1410. Pushy driver personality data 1401 (as in FIG. 14) comprises data value, preferably scalar data, regarding the self-perception of the overall pushy driver personality characteristics of the assistant. Input as a result of being prompted on assistant device 500. Severe driver personality data 1402 (as in FIG. 14) comprises data value, preferably scalar data, regarding the self-perception of the overall severe driver personality characteristics of the assistant. Input as a result of being prompted on assistant device 500.

Tough driver personality data 1403 (as in FIG. 14) comprises data value, preferably scalar data, regarding the self-perception of the overall tough driver personality characteristics of the assistant. Input as a result of being prompted on assistant device 500. Dominating driver personality data 1404 (as in FIG. 14) comprises data value, preferably scalar data, regarding the self-perception of the overall dominating driver personality characteristics of the assistant. Input as a result of being prompted on assistant device 500. Harsh driver personality data 1405 (as in FIG. 14) comprises data value, preferably scalar data, regarding the self-perception of the overall harsh driver personality characteristics of the assistant. Input as a result of being prompted on assistant device 500.

Strong-willed driver personality data 1406 (as in FIG. 14) comprises data value, preferably scalar data, regarding the self-perception of the overall strong-willed driver personality characteristics of the assistant. Input as a result of being prompted on assistant device 500. Independent driver personality data 1407 (as in FIG. 14) comprises data value, preferably scalar data, regarding the self-perception of the overall independent driver personality characteristics of the assistant. Input as a result of being prompted on assistant device 500. Practical driver personality data 1408 (as in FIG. 14) comprises data value, preferably scalar data, regarding the self-perception of the overall practical driver personality characteristics of the assistant.

Input as a result of being prompted on assistant device 500. Decisive driver personality data 1409 (as in FIG. 14) comprises data value, preferably scalar data, regarding the self-perception of the overall decisive driver personality characteristics of the assistant. Input as a result of being prompted on assistant device 500. Efficient driver personality data 1410 (as in FIG. 14) comprises data value, preferably scalar data, regarding the self-perception of the overall efficient driver personality characteristics of the assistant. Input as a result of being prompted on assistant device 500.

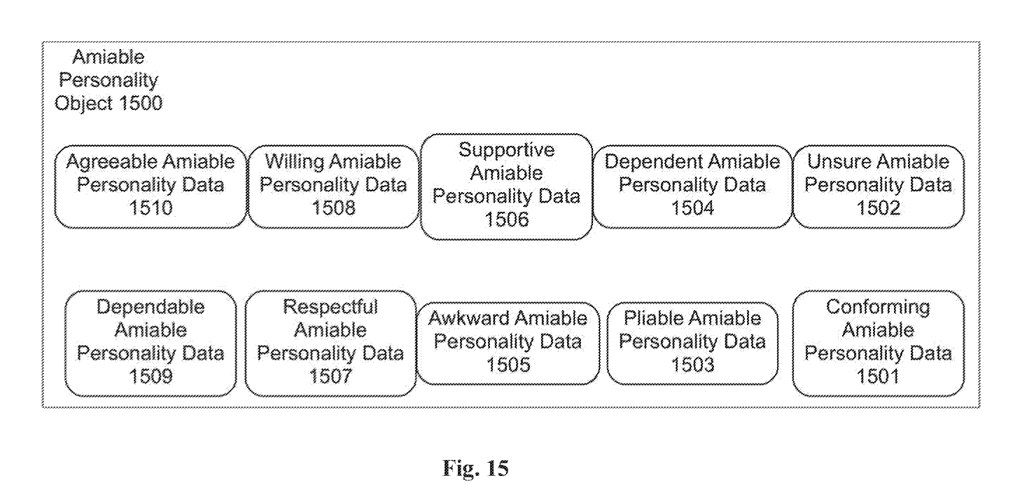

Referring now to FIG. 15 are relationships of the amiable personality object module and its submodules. Amiable personality object 1500 (as in FIG. 15) comprises a data object for amiable characteristics of personality data. Amiable personality object 1500 preferably comprises conforming amiable personality data 1501, unsure amiable personality data 1502, pliable amiable personality data 1503, dependent amiable personality data 1504, awkward amiable personality data 1505, supportive amiable personality data 1506, respectful amiable personality data 1507, willing amiable personality data 1508, dependable amiable personality data 1509, and agreeable amiable personality data 1510. Conforming amiable personality data 1501 (as in FIG. 15) comprises data value, preferably scalar data, regarding the self-perception of the overall conforming amiable personality characteristics of the assistant. Input as a result of being prompted on assistant device 500. Unsure amiable personality data 1502 (as in FIG. 15) comprises data value, preferably scalar data, regarding the self-perception of the overall unsure amiable personality characteristics of the assistant. Input as a result of being prompted on assistant device 500.

Pliable amiable personality data 1503 (as in FIG. 15) comprises data value, preferably scalar data, regarding the self-perception of the overall pliable amiable personality characteristics of the assistant. Input as a result of being prompted on assistant device 500. Dependent amiable personality data 1504 (as in FIG. 15) comprises data value, preferably scalar data, regarding the self-perception of the overall dependent amiable personality characteristics of the assistant. Input as a result of being prompted on assistant device 500. Awkward amiable personality data 1505 (as in FIG. 15) comprises data value, preferably scalar data, regarding the self-perception of the overall awkward amiable personality characteristics of the assistant. Input as a result of being prompted on assistant device 500.

Supportive amiable personality data 1506 (as in FIG. 15) comprises data value, preferably scalar data, regarding the self-perception of the overall supportive amiable personality characteristics of the assistant. Input as a result of being prompted on assistant device 500. Respectful amiable personality data 1507 (as in FIG. 15) comprises data value, preferably scalar data, regarding the self-perception of the overall respectful amiable personality characteristics of the assistant. Input as a result of being prompted on assistant device 500. Willing amiable personality data 1508 (as in FIG. 15) comprises data value, preferably scalar data, regarding the self-perception of the overall willing amiable personality characteristics of the assistant. Input as a result of being prompted on assistant device 500.

Dependable amiable personality data 1509 (as in FIG. 15) comprises data value, preferably scalar data, regarding the self-perception of the overall dependable amiable personality characteristics of the assistant. Input as a result of being prompted on assistant device 500. Agreeable amiable personality data 1510 (as in FIG. 15) comprises data value, preferably scalar data, regarding the self-perception of the overall agreeable amiable personality characteristics of the assistant. Input as a result of being prompted on assistant device 500.

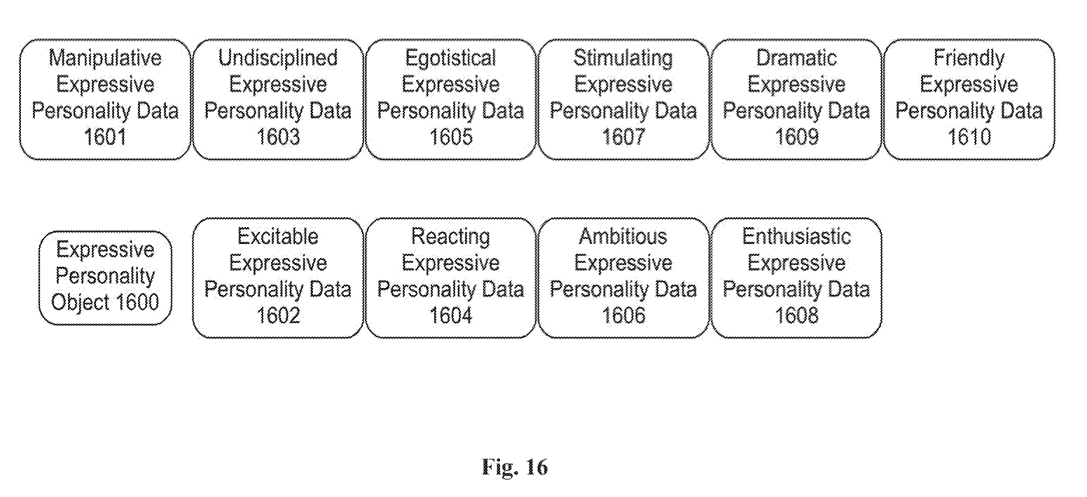

Referring now to FIG. 16 are relationships of the expressive personality object module and its submodules. Expressive personality object 1600 (as in FIG. 16) comprises a data object for expressiveness characteristics of personality data. Expressive personality object 1600 preferably comprises manipulative expressive personality data 1601, excitable expressive personality data 1602, undisciplined expressive personality data 1603, reacting expressive personality data 1604, egotistical expressive personality data 1605, ambitious expressive personality data 1606, stimulating expressive personality data 1607, enthusiastic expressive personality data 1608, dramatic expressive personality data 1609, and friendly expressive personality data 1610. Manipulative expressive personality data 1601 (as in FIG. 16) comprises data value, preferably scalar data, regarding the self-perception of the overall manipulative expressive personality characteristics of the assistant. Input as a result of being prompted on assistant device 500. Excitable expressive personality data 1602 (as in FIG. 16) comprises data value, preferably scalar data, regarding the self-perception of the overall excitable expressive personality characteristics of the assistant. Input as a result of being prompted on assistant device 500.

Undisciplined expressive personality data 1603 (as in FIG. 16) comprises data value, preferably scalar data, regarding the self-perception of the overall undisciplined expressive personality characteristics of the assistant. Input as a result of being prompted on assistant device 500. Reacting expressive personality data 1604 (as in FIG. 16) comprises data value, preferably scalar data, regarding the self-perception of the overall reacting expressive personality characteristics of the assistant. Input as a result of being prompted on assistant device 500. Egotistical expressive personality data 1605 (as in FIG. 16) comprises data value, preferably scalar data, regarding the self-perception of the overall egotistical expressive personality characteristics of the assistant. Input as a result of being prompted on assistant device 500.

Ambitious expressive personality data 1606 (as in FIG. 16) comprises data value, preferably scalar data, regarding the self-perception of the overall ambitious expressive personality characteristics of the assistant. Input as a result of being prompted on assistant device 500. Stimulating expressive personality data 1607 (as in FIG. 16) comprises data value, preferably scalar data, regarding the self-perception of the overall stimulating expressive personality characteristics of the assistant. Input as a result of being prompted on assistant device 500. Enthusiastic expressive personality data 1608 (as in FIG. 16) comprises data value, preferably scalar data, regarding the self-perception of the overall enthusiastic expressive personality characteristics of the assistant. Input as a result of being prompted on assistant device 500.

Dramatic expressive personality data 1609 (as in FIG. 16) comprises data value, preferably scalar data, regarding the self-perception of the overall dramatic expressive personality characteristics of the assistant. Input as a result of being prompted on assistant device 500. Friendly expressive personality data 1610 (as in FIG. 16) comprises data value, preferably scalar data, regarding the self-perception of the overall friendly expressive personality characteristics of the assistant. Input as a result of being prompted on assistant device 500.

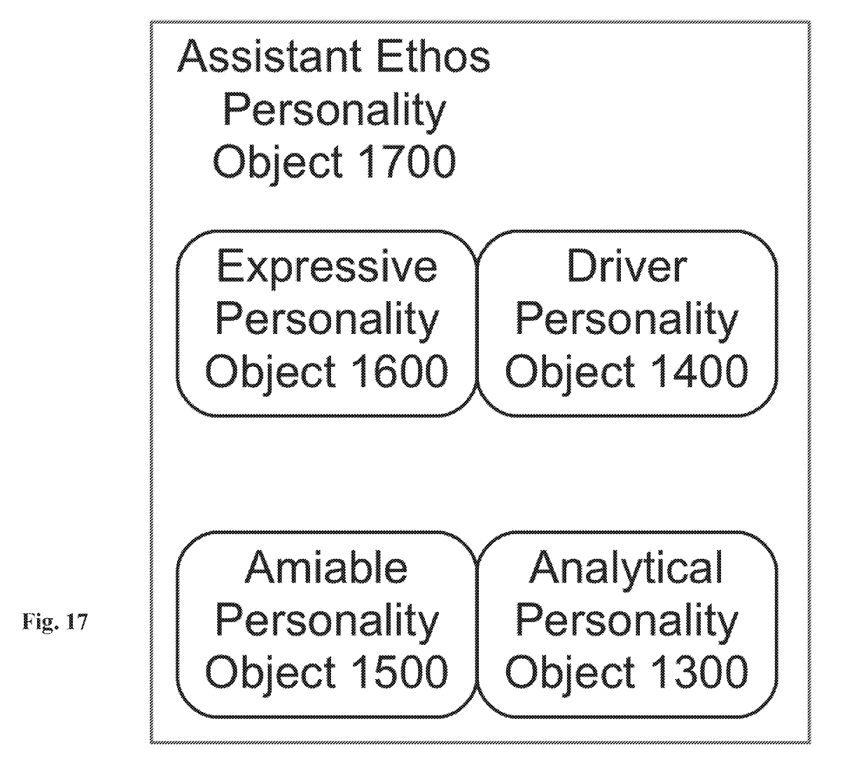

Referring now to FIG. 17 are relationships of the assistant ethos personality object module and its submodules. Assistant ethos personality object 1700 (as in FIG. 17) comprises a data object for assistant personality data. Assistant ethos personality object 1700 preferably comprises analytical personality object 1300, driver personality object 1400, amiable personality object 1500, and expressive personality object 1600.

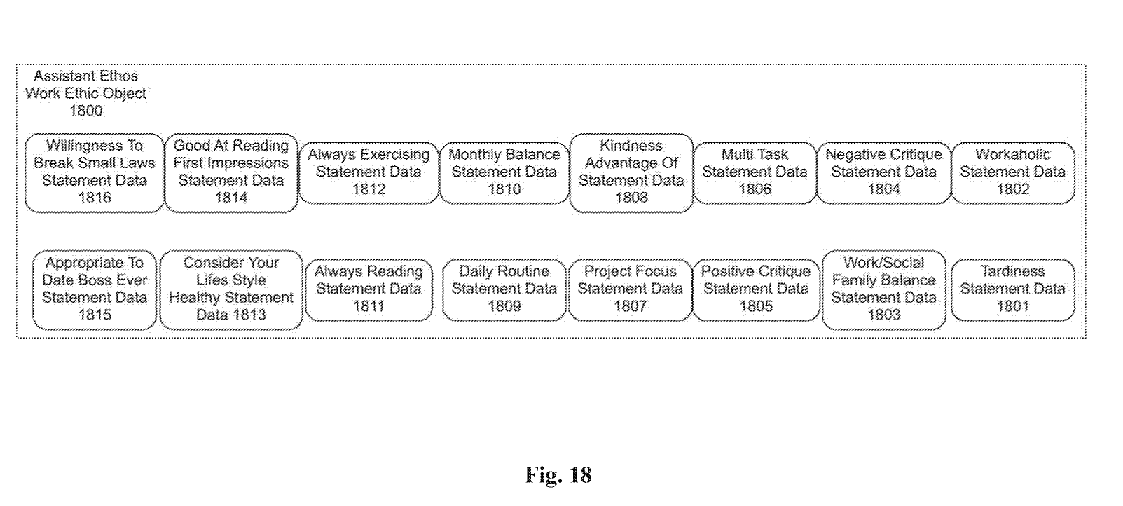

Referring now to FIG. 18 are relationships of the assistant ethos work ethic object module and its submodules. Assistant ethos work ethic object 1800 (as in FIG. 18) comprises a data object for assistant work ethic data. Assistant ethos work ethic object 1800 preferably comprises tardiness statement data 1801, workaholic statement data 1802, work/social family balance statement data 1803, negative critique statement data 1804, positive critique statement data 1805, multi-task statement data 1806, project focus statement data 1807, kindness advantage of statement data 1808, daily routine statement data 1809, monthly balance statement data 1810, always reading statement data 1811, always exercising statement data 1812, consider your lifestyle healthy statement data 1813, good at reading first impressions statement data 1814, appropriate to date supervisor ever statement data 1815, and willingness to break small laws statement data 1816. Tardiness statement data 1801 (as in FIG. 18) comprises data value, preferably scalar data, regarding the self-perception of the importance of a tardiness statement to the assistant. Input as a result of being prompted on assistant device 500. Workaholic statement data 1802 (as in FIG. 18) comprises data value, preferably scalar data, regarding the self-perception of the importance of a workaholic statement to the assistant. Input as a result of being prompted on assistant device 500.

Work/social family balance statement data 1803 (as in FIG. 18) comprises data value, preferably scalar data, regarding the self-perception of the importance of a work/social family balance statement to the assistant. Input as a result of being prompted on assistant device 500. Negative critique statement data 1804 (as in FIG. 18) comprises data value, preferably scalar data, regarding the self-perception of the importance of a negative critique statement to the assistant. Input as a result of being prompted on assistant device 500. Positive critique statement data 1805 (as in FIG. 18) comprises data value, preferably scalar data, regarding the self-perception of the importance of a positive critique statement to the assistant. Input as a result of being prompted on assistant device 500.

Multi-task statement data 1806 (as in FIG. 18) comprises data value, preferably scalar data, regarding the self-perception of the importance of a multi-task statement to the assistant. Input as a result of being prompted on assistant device 500. Project focus statement data 1807 (as in FIG. 18) comprises data value, preferably scalar data, regarding the self-perception of the importance of a project focus statement to the assistant. Input as a result of being prompted on assistant device 500. Kindness advantage of statement data 1808 (as in FIG. 18) comprises data value, preferably scalar data, regarding the self-perception of the importance of a kindness advantage statement to the assistant. Input as a result of being prompted on assistant device 500.

Daily routine statement data 1809 (as in FIG. 18) comprises data value, preferably scalar data, regarding the self-perception of the importance of a daily routine statement to the assistant. Input as a result of being prompted on assistant device 500. Monthly balance statement data 1810 (as in FIG. 18) comprises data value, preferably scalar data, regarding the self-perception of the importance of a monthly balance statement to the assistant. Input as a result of being prompted on assistant device 500. Always reading statement data 1811 (as in FIG. 18) comprises data value, preferably scalar data, regarding the self-perception of the importance of an always reading statement to the assistant. Input as a result of being prompted on assistant device 500.

Always exercising statement data 1812 (as in FIG. 18) comprises data value, preferably scalar data, regarding the self-perception of the importance of an always exercising statement to the assistant. Input as a result of being prompted on assistant device 500. Consider your lifestyle healthy statement data 1813 (as in FIG. 18) comprises data value, preferably scalar data, regarding the self-perception of the importance of a consider your lifestyle healthy statement to the assistant. Input as a result of being prompted on assistant device 500. Good at reading first impressions statement data 1814 (as in FIG. 18) comprises data value, preferably scalar data, regarding the self-perception of the importance of a ‘good at reading first impressions’ statement to the assistant. Input as a result of being prompted on assistant device 500.

Appropriate to date supervisor ever statement data 1815 (as in FIG. 18) comprises data value, preferably scalar data, regarding the self-perception of the importance of a ‘appropriate to date supervisor ever’ statement to the assistant. Input as a result of being prompted on assistant device 500. Willingness to break small laws statement data 1816 (as in FIG. 18) comprises data value, preferably scalar data, regarding the self-perception of the importance of a Willingness to break small laws' statement to the assistant. Input as a result of being prompted on assistant device 500.

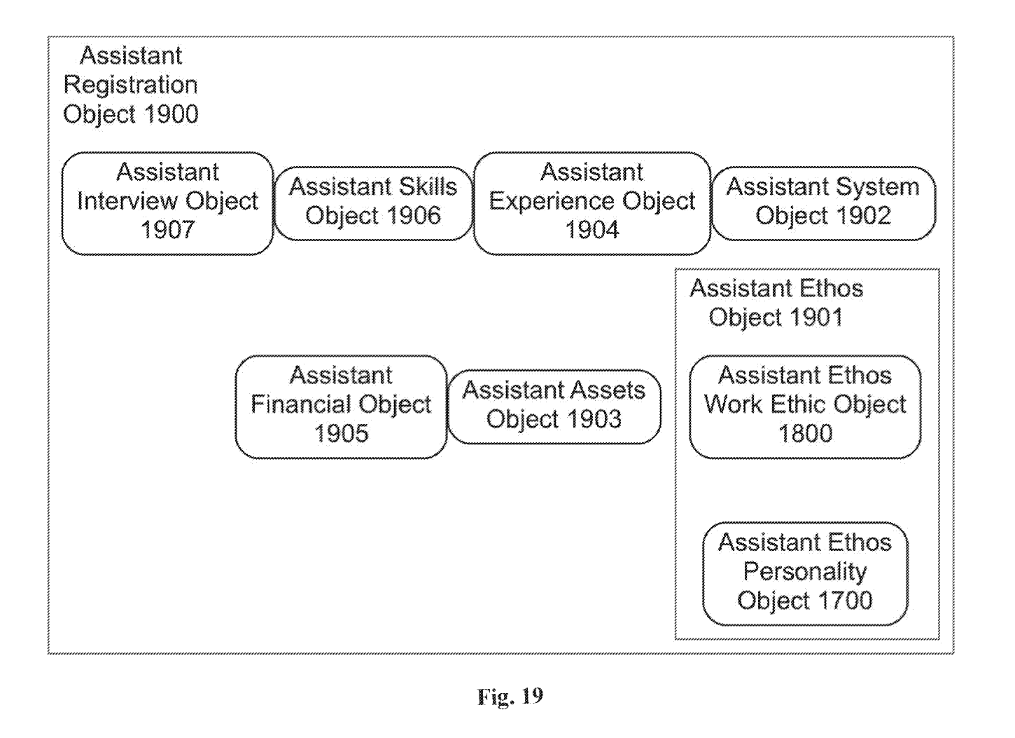

Referring now to FIG. 19 are relationships of the assistant registration object module and its submodules. Assistant registration object 1900 (as in FIG. 19) comprises the properties or attributes input by assistant device 500 that are uniquely identifiable to a user that allows for interaction with features of DAPS 502. Assistant registration object 1900 preferably comprises assistant ethos object 1901, assistant system object 1902, assistant assets object 1903, assistant experience object 1904, assistant financial object 1905, assistant skills object 1906, and assistant interview object 1907. Assistant ethos object 1901 (as in FIG. 19) comprises a data object for assistant personality data and work ethic data. Assistant ethos object 1901 preferably comprises assistant ethos personality object 1700 and assistant ethos work ethic object 1800. Assistant system object 1902 (as in FIG. 19) comprises a data object for system wide identification for an assistant as submitted by one or more assistant device 500. In some embodiments, assistant system object 1902 may include: email data, address data, current address data, image or picture data, name data, or birthday data.

Assistant assets object 1903 (as in FIG. 19) comprises a data object for capturing the technical or physical requirements needed for a job description. In some embodiments, assistant assets object 1903 may include: a passport, certifications, degrees, a driver's license, a license, training certifications, training licenses, a vehicle, a laptop, or a computer. Assistant experience object 1904 (as in FIG. 19) comprises a data object for capturing the previous experience of an assistant. In some embodiments, assistant experience object 1904 may include: past cities, duration of time stayed for each of past cities, work status (intern, experienced, novice), supervisor network names (input of names of all people in the network), or assistant network names (input of names of all people in the network). Assistant financial object 1905 (as in FIG. 19) comprises a data object for capturing the financial information of an assistant. In some embodiments, assistant financial object 1905 may include: banking information, a work rate, a work rate negotiability, or a current city.

Assistant skills object 1906 (as in FIG. 19) comprises a data object for capturing the skills that an assistant may/may not possess. In some embodiments, assistant skills object 1906 may be a language ability or perhaps computer skills and the like. Assistant interview object 1907 (as in FIG. 19) comprises a data object for capturing the preferred parameters for conducting and receiving interview requests. In some embodiments, assistant interview object 1907 may include: teleconference handle data, phone number data, alternate email account data, or physical locations where available to meet data.

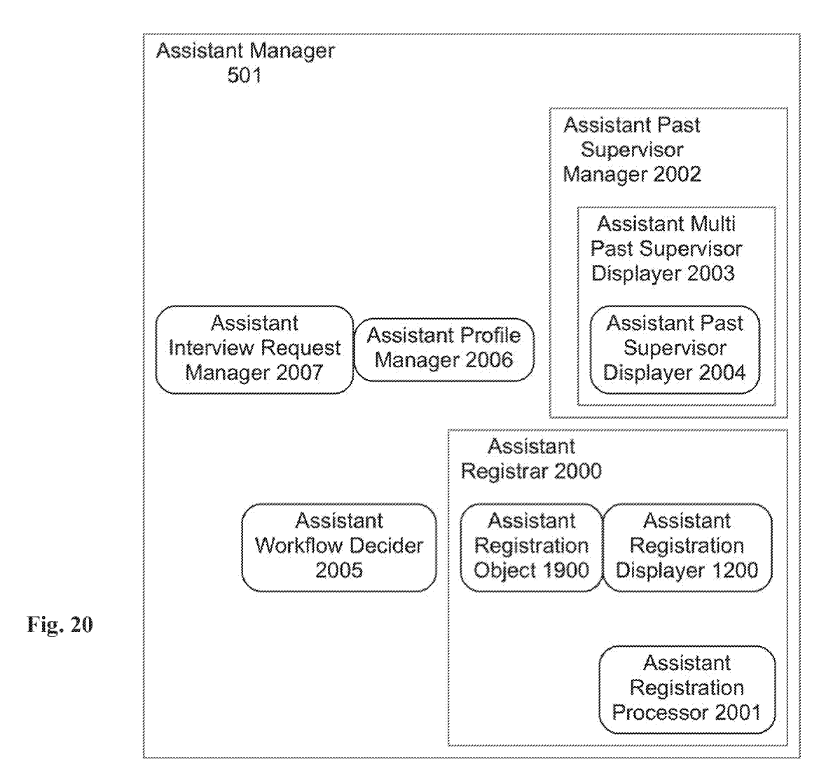

Referring now to FIG. 20 are relationships of the assistant manager module and its submodules. Assistant registrar 2000 (as in FIG. 20) comprises a module that manages the registration components mediated by an assistant device. Assistant registrar 2000 preferably comprises assistant registration processor 2001, assistant registration displayer 1200, and assistant registration object 1900. Assistant past supervisor manager 2002 (as in FIG. 20) comprises a module that manages the processing, storage and management of past supervisors associated with an assistant. May include the ability to add/edit data such as name, time worked, description of work performed, supervisor's company, title, and the ability to add a photo. Assistant past supervisor manager 2002 preferably comprises assistant multi past supervisor displayer 2003.

Assistant past supervisor displayer 2004 (as in FIG. 20) comprises an interactive view on assistant device 500 that may be representative of a previous working relationship between an assistant and a supervisor. Assistant multi past supervisor displayer 2003 (as in FIG. 20) comprises a module that displays multiple assistant past supervisor displayer 2004 interactive views on assistant device 500. Assistant multi past supervisor displayer 2003 preferably comprises assistant past supervisor displayer 2004. Assistant workflow decider 2005 (as in FIG. 20) comprises a module that manages the processing, storage, and general workflow logic of mediating interactions on assistant device 500.

Assistant profile manager 2006 (as in FIG. 20) comprises a module that manages the processing, storage and management of data associated with an assistant through assistant device 500 that mediates the creating, editing, and deleting of data associated with assistant registration object 1900. Assistant interview request manager 2007 (as in FIG. 20) comprises a module that manages the processing, storage and management of data associated with an interview request mediated through assistant device 500.

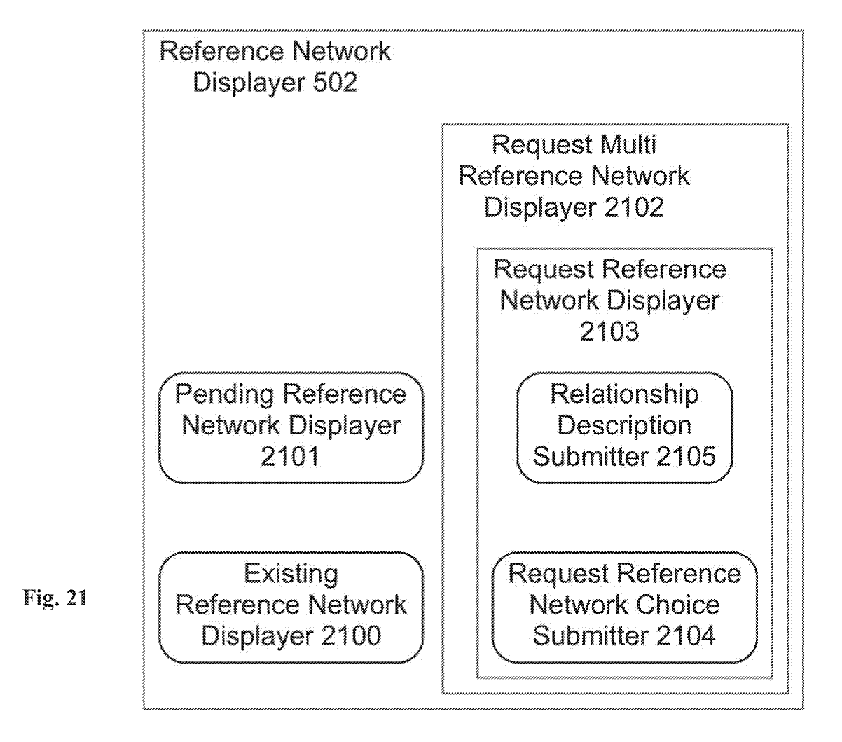

Referring now to FIG. 21 are relationships of the reference network displayer module and its submodules. Existing reference network displayer 2100 (as in FIG. 21) comprises a module that displays existing users linked via a reference network input. Pending reference network displayer 2101 (as in FIG. 21) comprises a module that displays pending users that are asked to be linked to a user, via the reference network input. Request multi reference network displayer 2102 (as in FIG. 21) comprises a module that displays a list of multiple requests from other users that would like to be linked via the reference network input. Request multi reference network displayer 2102 preferably comprises request reference network displayer 2103.

Request reference network displayer 2103 (as in FIG. 21) comprises a module that displays a single request from another user that would like to be linked via the reference network. Request reference network displayer 2103 preferably comprises request reference network choice submitter 2104 and relationship description submitter 2105. Request reference network choice submitter 2104 (as in FIG. 21) comprises a module that allows the choice of whether to accept a request from another user that would like to be linked via the reference network. Relationship description submitter 2105 (as in FIG. 21) comprises a module that allows the one to detail the extent of the relationship between the instance user and the requesting user with various prompting means. In some embodiments, relationship description submitter 2105 may include: a how long have you known the person prompt, a length of relationship prompt, a quality of relationship prompt, a frequency of contact prompt, a when first met prompt, or a last talked to prompt.

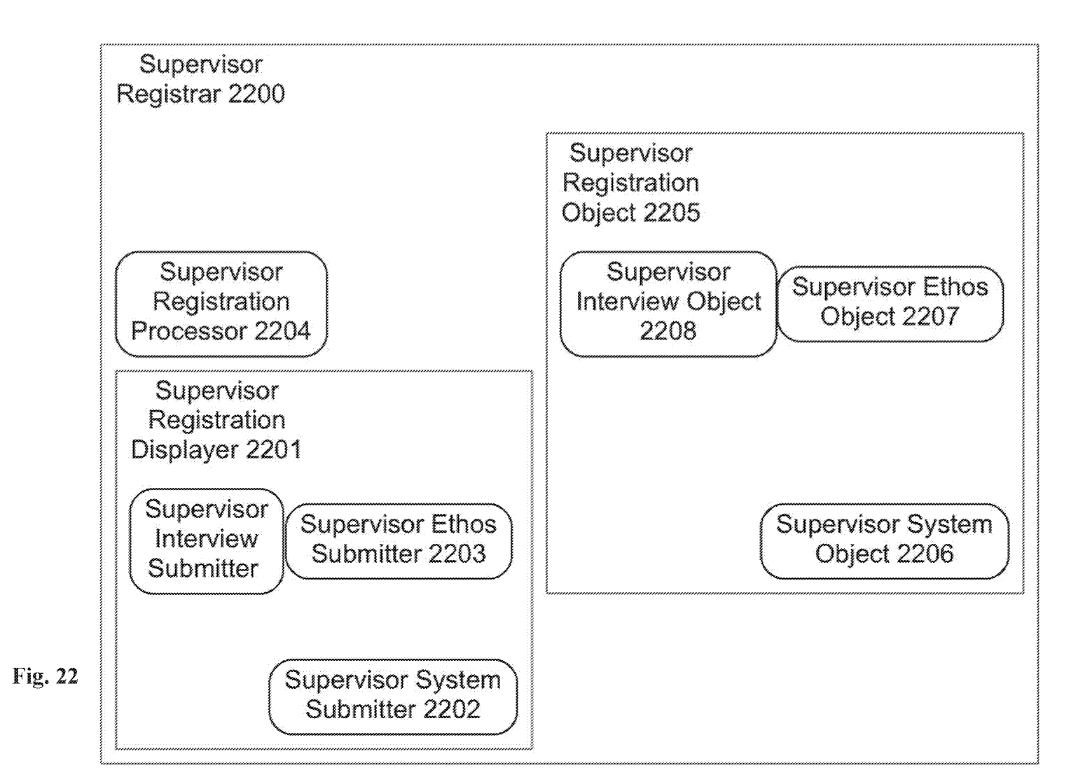

Referring now to FIG. 22 are relationships of the supervisor registrar module and its submodules. Supervisor registration displayer 2201 (as in FIG. 22) comprises a module that displays the supervisor registration components in order to accept input for supervisor registration object 2205. Supervisor registration displayer 2201 preferably comprises supervisor system submitter 2202 and supervisor ethos submitter 2203. Supervisor registration processor 2204 (as in FIG. 22) comprises a module that receives supervisor registration object 2205 for further processing and storage. Supervisor system submitter 2202 (as in FIG. 22) comprises a module that accepts data relative to a supervisor that may be uniquely identifying and in some embodiments preferably inherits the elements of supervisor ethos submitter 2203.

Supervisor ethos submitter 2203 (as in FIG. 22) comprises a module that collectively manages the display and submission of supervisor personality data and work ethic data and preferably inherits the elements of assistant ethos submitter 1100. Supervisor system object 2206 (as in FIG. 22) comprises a data object for system wide identification for a supervisor as submitted by one or more supervisor device 501. In some embodiments, supervisor system object 2206 may include: email data, address data, city data, picture data, network data, job title data, company data, or birthday data. Supervisor ethos object 2207 (as in FIG. 22) comprises a data object for assistant personality data and work ethic data preferably inheriting the elements of assistant ethos object 1901.

Supervisor interview object 2208 (as in FIG. 22) comprises a data object for capturing the preferred parameters for conducting and receiving interview requests. In some embodiments, supervisor interview object 2208 may include: teleconference handle data, phone # data, alternate email account data, or physical locations where available to meet data. Supervisor registration object 2205 (as in FIG. 22) comprises the properties or attributes input by supervisor device 501 and uniquely identifiable to a user that allows for interaction with features of DAPS 502.

Supervisor registration object 2205 preferably comprises supervisor system object 2206, supervisor ethos object 2207, and supervisor interview object 2208. Supervisor registrar 2200 (as in FIG. 22) comprises a module that manages the registration components mediated by a supervisor device. Supervisor registrar 2200 preferably comprises supervisor registration displayer 2201, supervisor registration processor 2204, and supervisor registration object 2205.

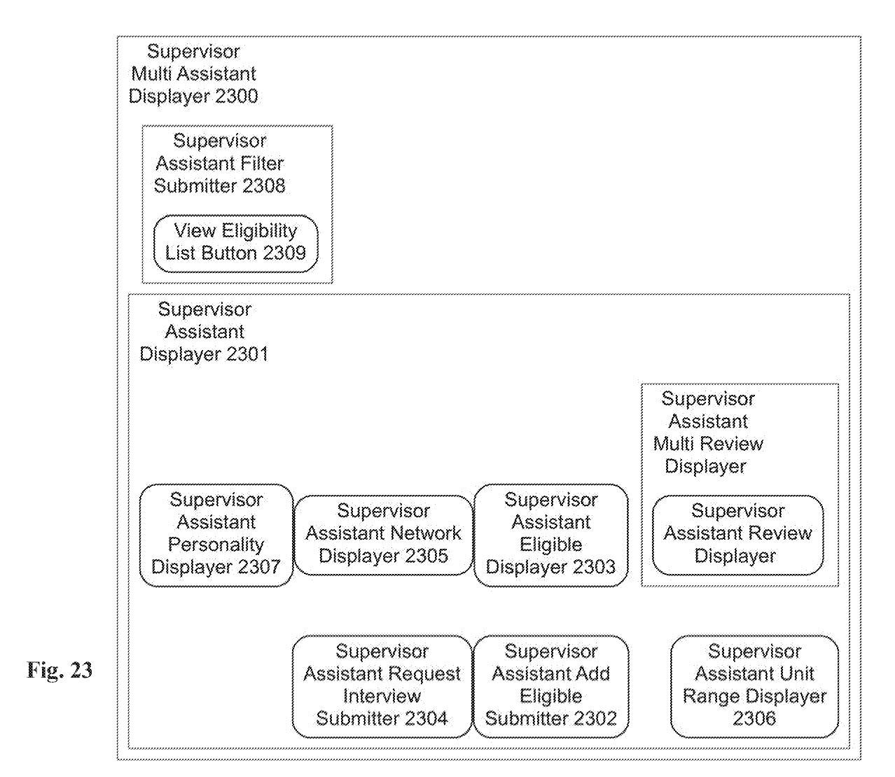

Referring now to FIG. 23 are relationships of the supervisor multi-assistant displayer module and its submodules. Supervisor multi-assistant displayer 2300 (as in FIG. 23) comprises a module that displays supervisor assistant displayer 2301 interactive views on supervisor device 501. Supervisor multi-assistant displayer 2300 preferably comprises supervisor assistant displayer 2301 and supervisor assistant filter submitter 2308. Supervisor assistant displayer 2301 (as in FIG. 23) comprises a module that displays one supervisor assistant displayer 2301 interactive view on supervisor device 501 and may be representative of a potential desired working relationship between an assistant and a supervisor. Supervisor assistant displayer 2301 preferably comprises supervisor assistant add eligible submitter 2302, supervisor assistant eligible displayer 2303, supervisor assistant request interview submitter 2304, supervisor assistant network displayer 2305, supervisor assistant unit range displayer 2306, and supervisor assistant personality displayer 2307. Supervisor assistant add eligible submitter 2302 (as in FIG. 23) comprises a module that allows the user to choose the instance assistant in supervisor assistant displayer 2301 and add that to the supervisor's eligibility list.

Supervisor assistant eligible displayer 2303 (as in FIG. 23) comprises a module that shows whether the instance assistant in supervisor assistant displayer 2301 may be already added to the supervisor's eligibility list. Supervisor assistant request interview submitter 2304 (as in FIG. 23) comprises a module that allows the user to request an interview from the instance assistant in supervisor assistant displayer 2301. Supervisor assistant network displayer 2305 (as in FIG. 23) comprises a module that allows the user to be directed to modules that show the instance assistant reference network in supervisor assistant displayer 2301.

Supervisor assistant unit range displayer 2306 (as in FIG. 23) comprises a module that shows the acceptable hiring price range for instance assistant in supervisor assistant displayer 2301. Supervisor assistant personality displayer 2307 (as in FIG. 23) comprises a module that allows the user to be directed to modules that show the instance assistant personality data in supervisor assistant displayer 2301.

Supervisor assistant filter submitter 2308 (as in FIG. 23) comprises a module that allows filtering of supervisor multi-assistant displayer 2300 preferably based on parameters in assistant registration object 1900 or supervisor registration object 2205. In some embodiments, supervisor assistant filter submitter 2308 may include: a city filter, an availability filter, a job type filter, a language filter, or an assets filter. Supervisor assistant filter submitter 2308 preferably comprises view eligibility list button 2309. View eligibility list button 2309 (as in FIG. 23) comprises a module that allows the redirect to supervisor eligible type manager 2407.

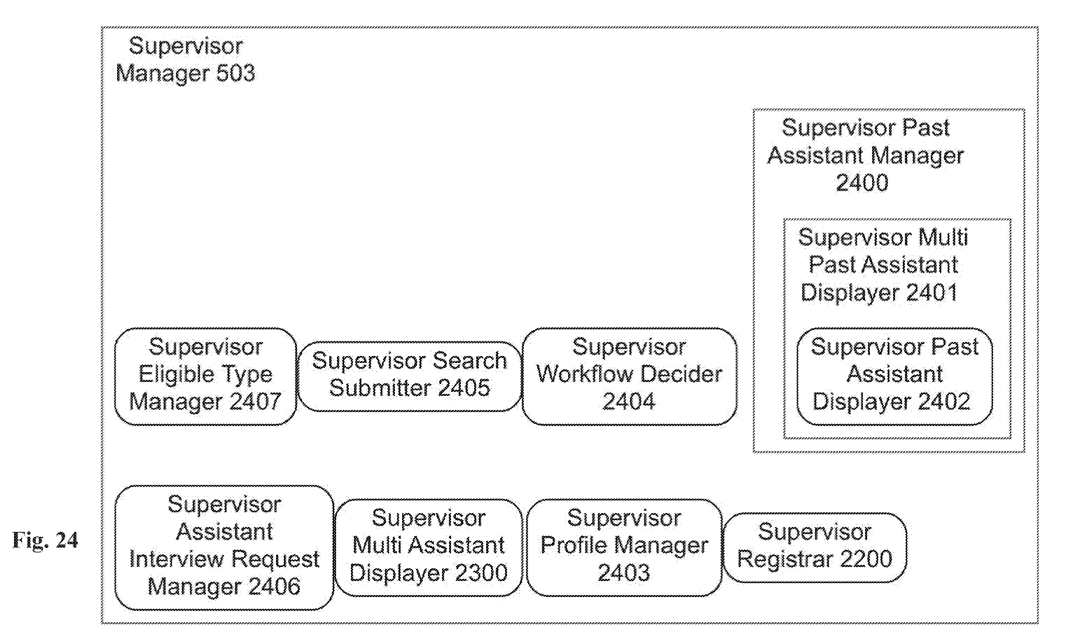

Referring now to FIG. 24 are relationships of the supervisor manager module and its submodules. Supervisor past assistant manager 2400 (as in FIG. 24) comprises a module that manages the processing, storage and management of past assistants associated with a supervisor. Supervisor past assistant manager 2400 preferably comprises supervisor multi past assistant displayer 2401. Supervisor multi past assistant displayer 2401 (as in FIG. 24) comprises a module that displays supervisor assistant past assistant displayer interactive views on supervisor device 501. Supervisor multi past assistant displayer 2401 preferably comprises supervisor past assistant displayer 2402. Supervisor past assistant displayer 2402 (as in FIG. 24) comprises a module that one supervisor past assistant displayer 2402 interactive view on supervisor device 501 and may be representative of a previous working relationship between an assistant and a supervisor.

Supervisor profile manager 2403 (as in FIG. 24) comprises a module that manages the processing, storage and management of data associated with a supervisor through supervisor device 501 that mediates the creating, editing, and deleting of data associated with supervisor registration object 2205. Supervisor workflow decider 2404 (as in FIG. 24) comprises a module that manages the processing, storage, and general workflow logic of mediating interactions on supervisor device 501. Supervisor search submitter 2405 (as in FIG. 24) comprises a module that accepts input and triages the beginning of a supervisor search for an assistant.

Supervisor assistant interview request manager 2406 (as in FIG. 24) comprises a module that manages the processing, storage and management of data associated with an interview request mediated through supervisor device 501.

Supervisor eligible type manager 2407 (as in FIG. 24) comprises a module that manages the creation, editing and deletion of assistant eligible types, which can be used to demarcate a desired assistant for potential roles, locations, or skills as determined by the supervisor.

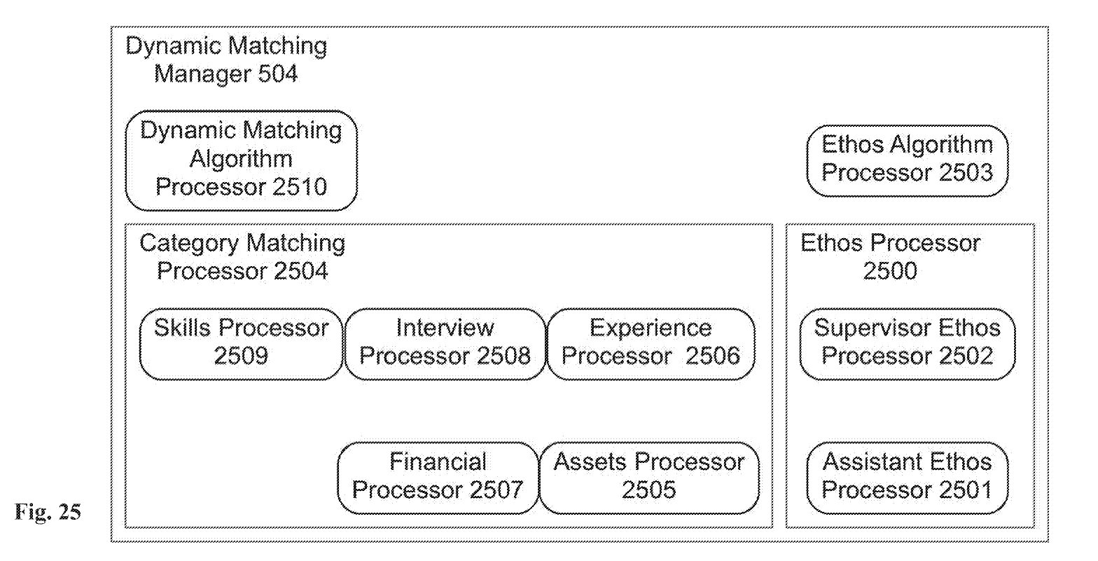

Referring now to FIG. 25 are relationships of the dynamic matching manager module and its submodules. Assistant ethos processor 2501 (as in FIG. 25) comprises a module that collects ethos data from the assistant registration object and which evaluates relationships and values of ethos data. Supervisor ethos processor 2502 (as in FIG. 25) comprises a module that collects ethos data from the supervisor registration object and which evaluates relationships and values of ethos data. Ethos processor 2500 (as in FIG. 25) comprises a module that collects ethos data and which evaluates relationships and values of ethos data. Ethos processor 2500 preferably comprises assistant ethos processor 2501 and supervisor ethos processor 2502.

Ethos algorithm processor 2503 (as in FIG. 25) comprises a module that evaluates the ethos data of an assistant registration object and compares that data do the ethos data of a supervisor registration object in order to prioritize or otherwise establish greater probabilities of successful matches between a supervisor and an assistant. Assets processor 2505 (as in FIG. 25) comprises a module that collect assets data and evaluates the relevant relationships and values. An experience processor 102 (as in FIG. 25) comprises a module that collects experience data and evaluates the relevant relationships and values.

Financial processor 2507 (as in FIG. 25) comprises a module that collects financial data and evaluates the relevant relationships and values. Interview processor 2508 (as in FIG. 25) comprises a module that collects interview data and evaluates the relevant relationships and values. Skills processor 2509 (as in FIG. 25) comprises a module that collect skills data and evaluates the relevant relationships and values.

Category matching processor 2504 (as in FIG. 25) comprises a module that evaluates the categorical data of an assistant registration object and compares that data to the relevant data of a supervisor registration object in order to prioritize or otherwise establish greater probabilities of successful matches between a supervisor and an assistant. Category matching processor 2504 preferably comprises assets processor 2505, an experience processor 102, financial processor 2507, interview processor 2508, and skills processor 2509. Dynamic matching algorithm processor 2510 (as in FIG. 25) comprises a module that evaluates category matching probabilities and ethos algorithm data in order to establish a greater probability of a successful match between a supervisor and an assistant.

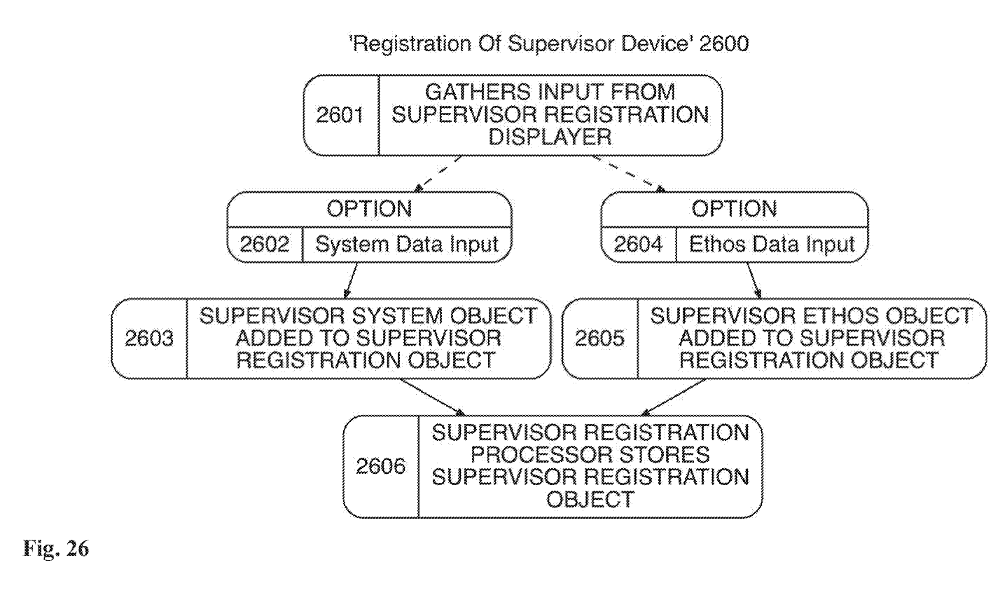

Referring now to FIG. 26, overall, a preferred embodiment of the invention may be used as follows: First, one or more computing device 100 interacts with device workflow parser 510 of DAPS 502 (step 2601). Next, the device workflow parser 510 prompts for device registration data with DAPS 502 (step 2602). If the registration data associated with the device is previously unregistered (step 2603) and if the user wants to search for an assistant (step 2604), then one preferably follows the steps detailed in (step 2701-step 2703) below and then proceeds to step 2610.

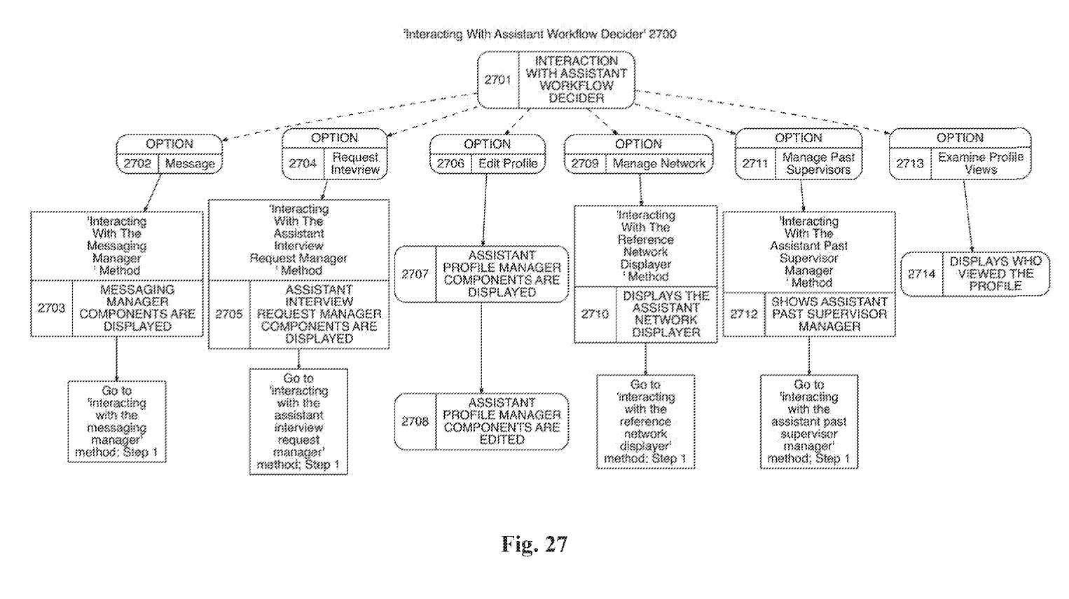

Now referring to FIG. 27, next, device workflow parser 510 identifies the computing device 100 as supervisor device 501 and supervisor device 501 displays one or more components of supervisor search submitter 2405 for interaction (step 2701). Next, dynamic matching manager 506 receives city, date, and type of assistant data from supervisor device 501 (step 2702). Next, supervisor device 501 sends data to supervisor manager 505 and receives result data that is displayed in supervisor multi-assistant displayer 2300 based on city, date, and type of assistant data (step 2703). This is further detailed below in (step 2801-step 2810).

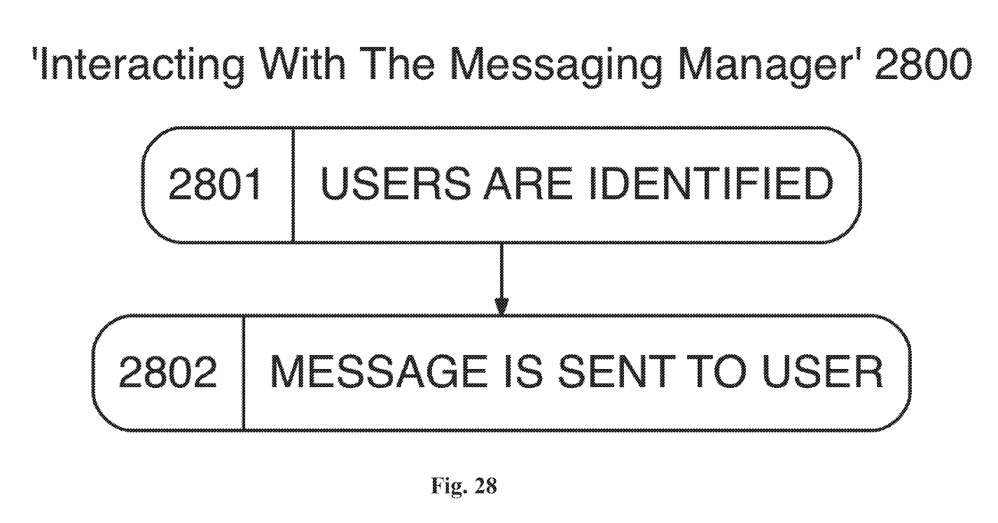

Now referring to FIG. 28, next, supervisor multi-assistant displayer 2300 loads multiple instances of assistant registration object 1900 preferably sorted by order of most experienced, then most networked (step 2801). Next, filter options are presented via supervisor assistant filter submitter 2308 (step 2802). If the supervisor wants to filter by network (step 2803), then this may occur, and one may proceed to step 2809. If the supervisor wants to filter by financial (step 2804), then this may occur, and one may proceed to step 2809. If the supervisor wants to filter by experience (step 2805), then this may occur, and one may proceed to step 2809. If the supervisor wants to filter by ethos (step 2806), then this may occur, and one may proceed to step 2809. If the supervisor wants to filter by skills (step 2807), then this may occur, and one may proceed to step 2809. If the supervisor wants to filter by assets (step 2808), then this may occur, and one may proceed to step 2809.

Next, filter data may be sent to dynamic matching manager 506 and are processed to redisplay instances of a plurality of assistant registration object 1900 in supervisor multi-assistant displayer 2300 (step 2809). Next, the supervisor interacts with the one or more supervisor assistant displayer 2301 on supervisor device 501 (step 2810). If the supervisor wants to request an interview with a particular assistant (step 2811) and if they want the interview to be done by teleconference (step 2812), then messaging manager 509 sends a message to the assistant and email notification may be sent (step 2813). Then, an interview request may be pushed to the designated assistant interview request manager 2007 (step 2814).

If the supervisor wants the interview to be done by phone (step 2815), then one proceeds to step 2813. If the supervisor wants the interview to be done in person (step 2816), then one proceeds to step 2813. If the supervisor wants to add to the eligibility list of a particular assistant (step 2817) and if they want to add a default eligible assistant type (step 2818) then this may occur.

Also, if they want to add to choose from an existing eligible assistant type (step 2819) this may occur. Further, if they want to add to create a new eligible assistant type (step 2820), then, the device may redirect straight to supervisor eligible type manager 2407 (step 2821).

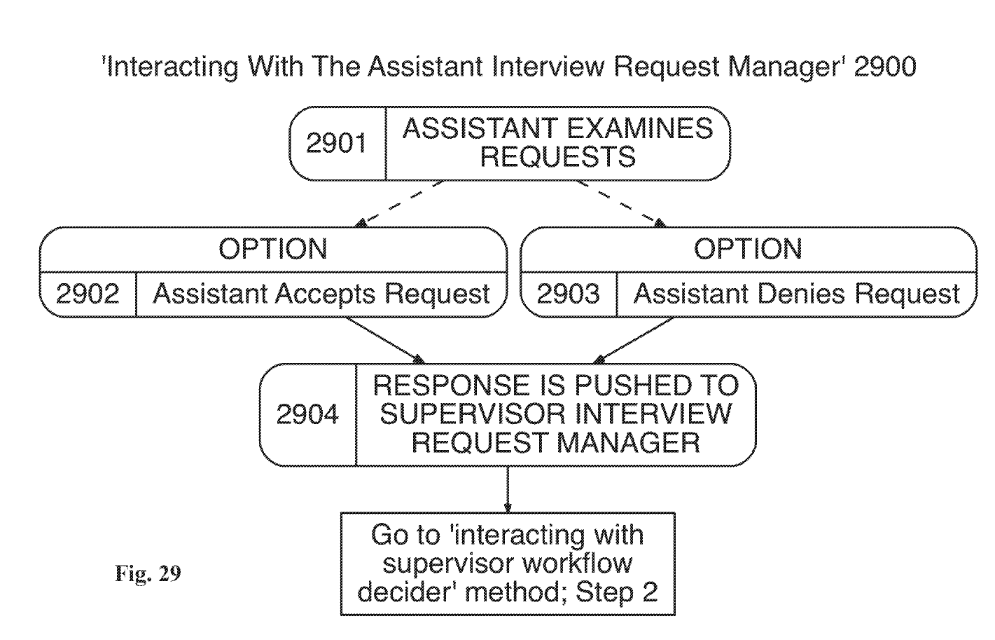

Referring again to FIG. 26, if the user wants to register for DAPS 502 (step 2605), then one preferably follows the steps detailed in the steps below (referring to FIG. 29), and then proceeds to step 2610.

Now referring to FIG. 29, next, the device sends data to the device registrar indicating that it may be either supervisor device 501 or assistant device 500 (step 2901). If the indication is that it is assistant device 500 (step 2902), then one preferably follows the steps detailed in (step 3001-step 3014) below.

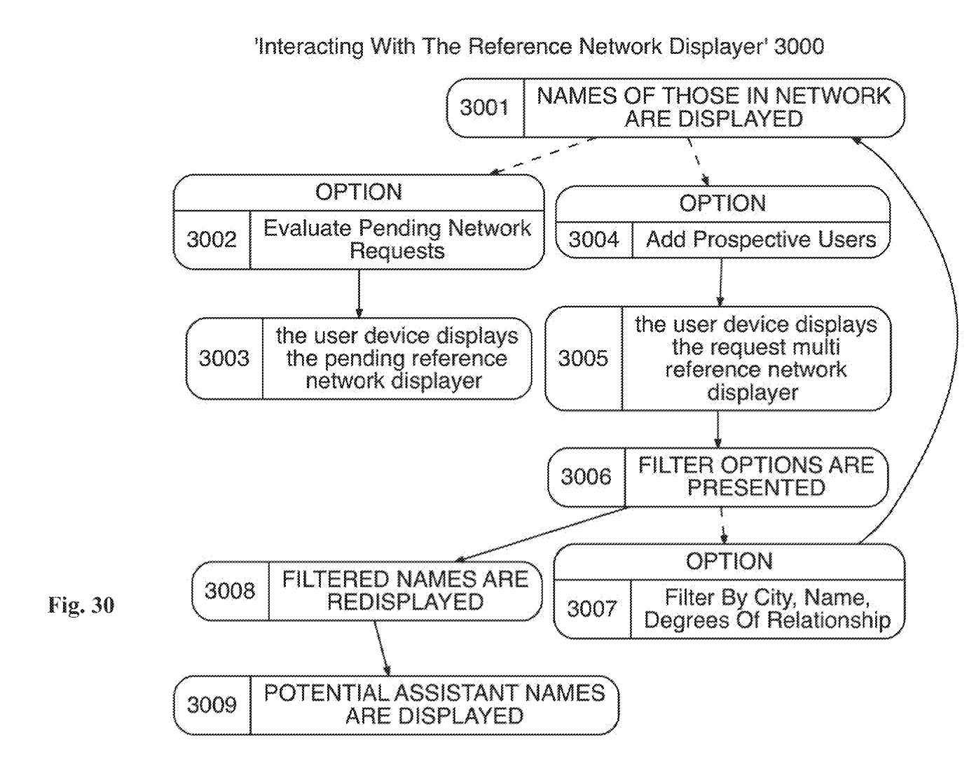

Now referring to FIG. 30, next, assistant device 500 displays and receives input from assistant registration displayer 1200 (step 3001). If there is input of ethos data from assistant device 500 (step 3002), then assistant registration object 1900 adds assistant ethos object 1901 from assistant ethos submitter 1100 (step 3003) as detailed in (step 3101-step 3102) below.

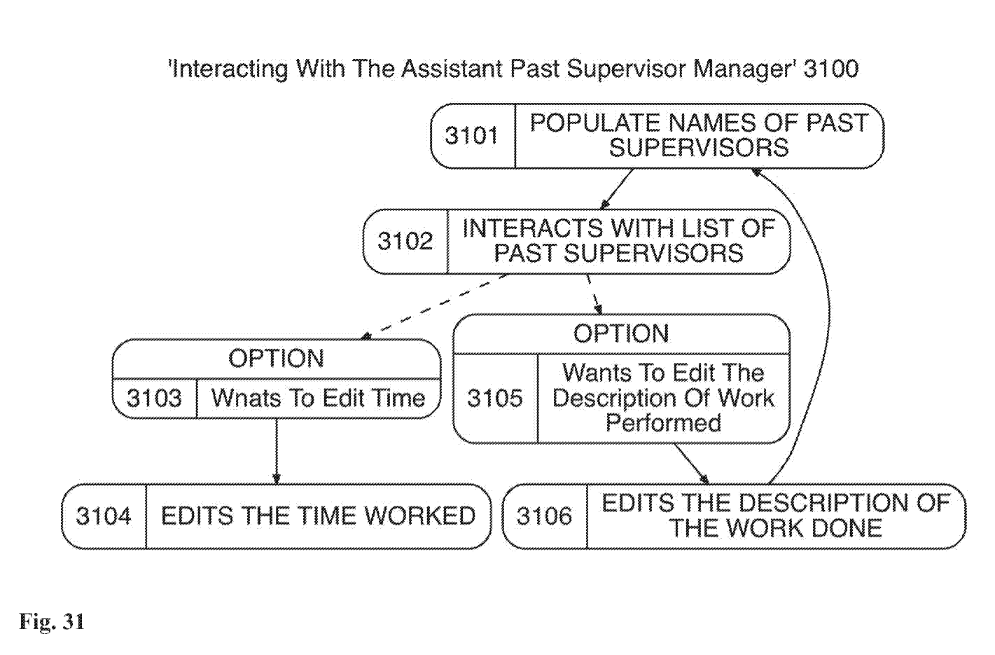

Now referring to FIG. 31, next, assistant ethos object 1901 adds assistant ethos personality object 1700 from assistant ethos personality submitter 1101 (step 3101). This is further detailed below in (step 3201-step 3204).

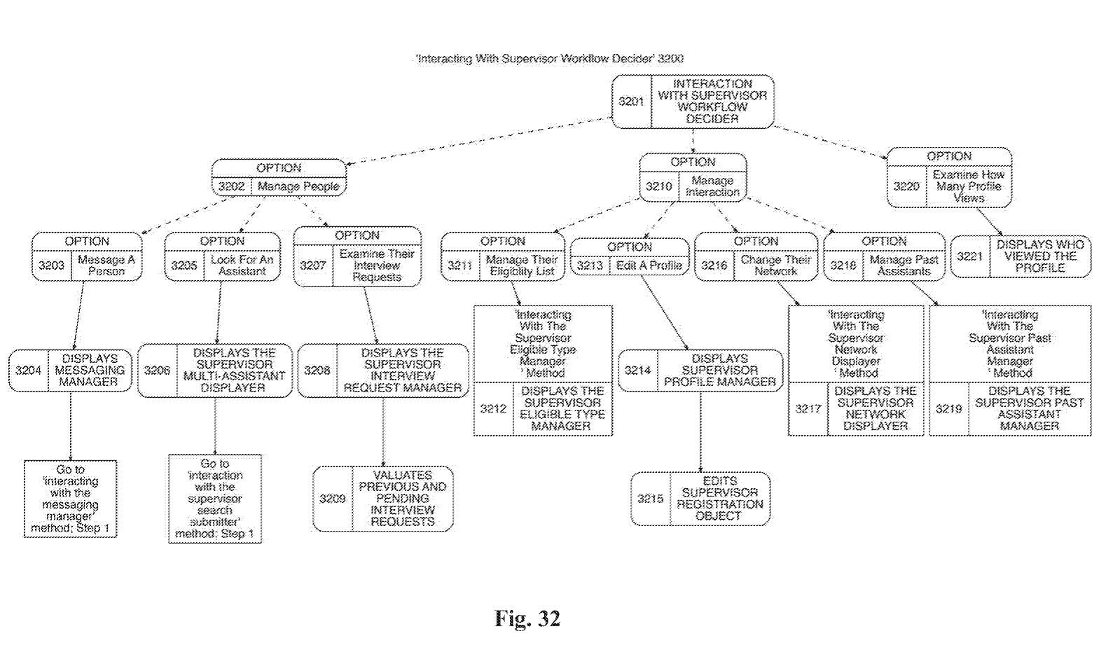

Now referring to FIG. 32, next, assistant ethos personality object 1700 adds analytical personality object 1300 from analytical personality submitter 700 (step 3201). Next, assistant ethos personality object 1700 adds driver personality object 1400 from driver personality submitter 800 (step 3202). Next, assistant ethos personality object 1700 adds amiable personality object 1500 from amiable personality submitter 900 (step 3203). Next, assistant ethos personality object 1700 adds expressive personality object 1600 from expressive personality submitter 1000 (step 3204).

Referring again to FIG. 31, next, assistant ethos object 1901 adds assistant ethos work ethic object 1800 from assistant ethos work ethic submitter 600 (step 3102). If there is input of system data from assistant device 500 (step 3004), then assistant registration object 1900 adds assistant system object 1902 from assistant system submitter 1201 (step 3005). If there is input of assets data from assistant device 500 (step 3006), then assistant registration object 1900 adds assistant assets object 1903 from assistant assets submitter 1202 (step 3007). If there is input of experience data from assistant device 500 (step 3008), then assistant registration object 1900 adds assistant experience object 1904 from assistant experience submitter 1203 (step 3009). If there is input of skill data from assistant device 500 (step 3010), then assistant registration object 1900 adds assistant skills object 1906 from assistant skills submitter 1205 (step 3011). If there is input of financial data from assistant device 500 (step 3012), then assistant registration object 1900 adds assistant financial object 1905 from assistant financial submitter 1204 (step 3013). Next, assistant registration processor 2001 (of assistant registrar 2000) receives assistant registration object 1900 from assistant device 500 (step 3014). If the indication that is that it is supervisor device 501 (step 2903), then one preferably follows the steps detailed in (step 3301-step 3306) below.

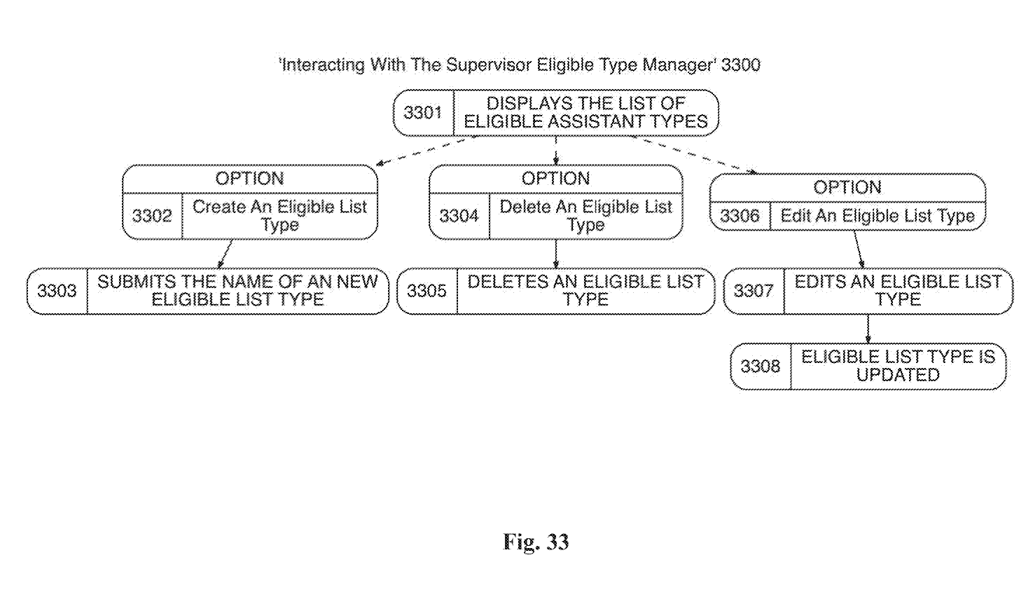

Now referring to FIG. 33, next, supervisor device 501 displays and receives input from supervisor registration displayer 2201 (step 3301). If there is input of system data from supervisor device 501 (step 3302), then supervisor registration object 2205 adds supervisor system object 2206 from supervisor system submitter 2202 (step 3303). If there is input of ethos data from supervisor device 501 (step 3304), then supervisor registration object 2205 adds supervisor ethos object 2207 from supervisor ethos submitter 2203 (step 3305). Next, supervisor registration processor 2204 receives supervisor registration object 2205 from supervisor device 501 (step 3306). If the registration data associated with the device is previously registered as assistant device 500 (step 2606), then computing device 100 becomes assistant device 500 displays one or more components of assistant workflow decider 2005 for interaction (step 2607) as detailed in steps below.

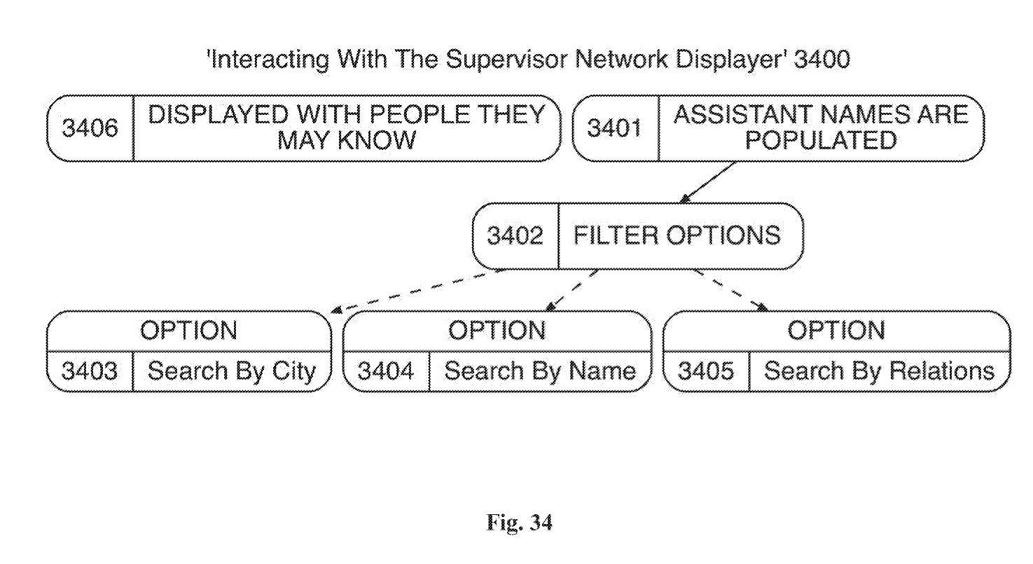

Now referring to FIG. 34, next, assistant device 500 interacts with one or more components of assistant workflow decider 2005 (step 3401). If an assistant wants to message a person (step 3402), then assistant device 500 displays one or more components of messaging manager 509 (step 3403) as detailed in (step 3501-step 3502) below.

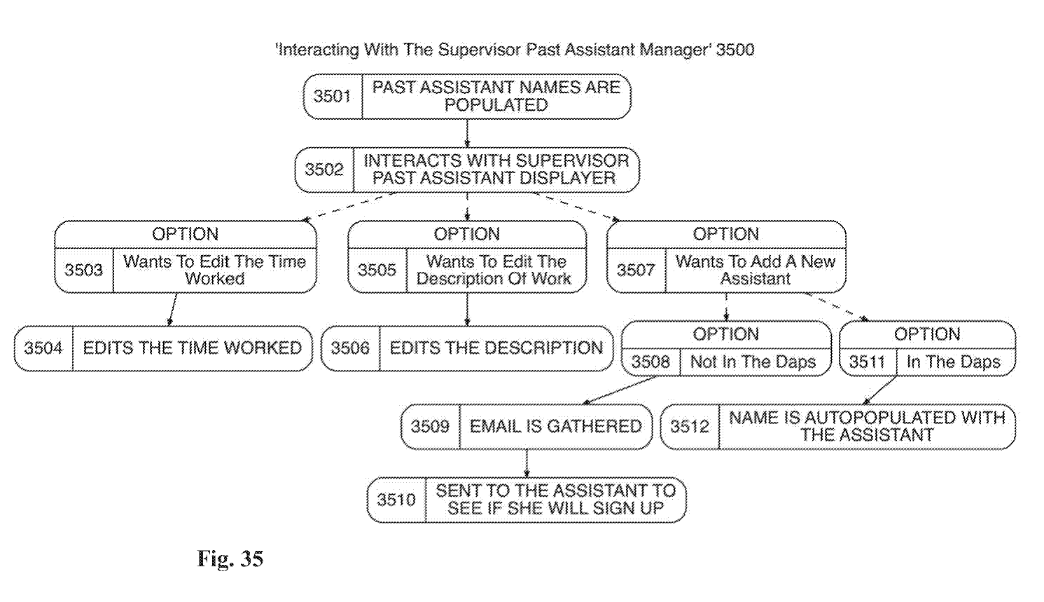

Now referring to FIG. 35, next, one or more users are selected that messages are desired to be sent to (step 3501). Next, a message may be sent to the user device via messaging manager 509 (step 3502). If assistant wants to respond to an interview request (step 3404), then assistant device 500 displays one or more components of assistant interview request manager 2007 (step 3405) as detailed in (step 3601-step 3604) below.

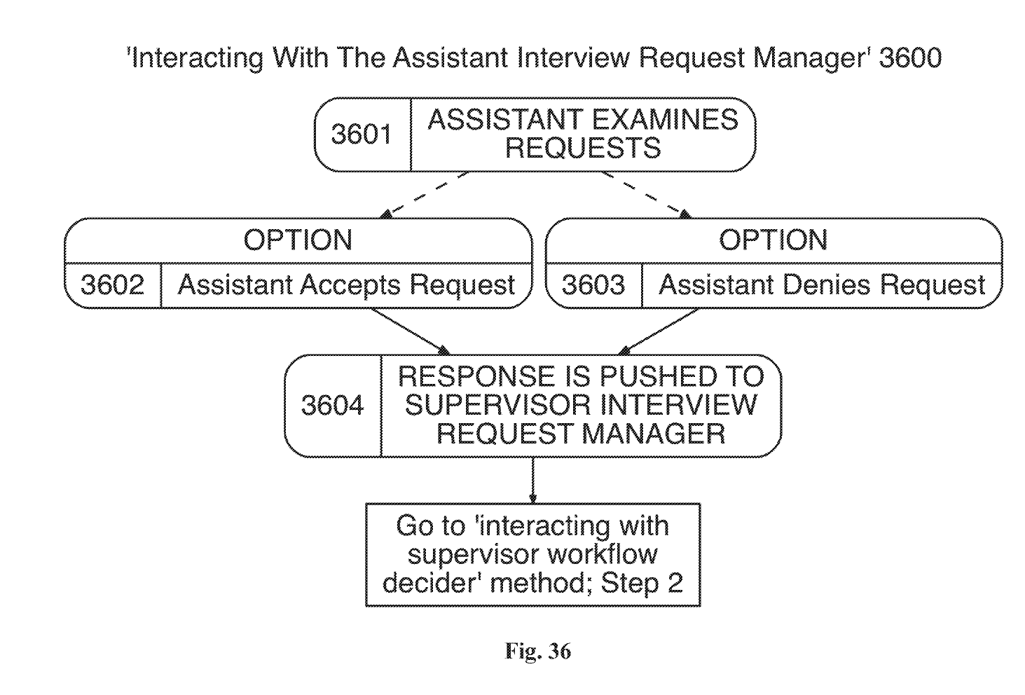

Now referring to FIG. 36, next, the assistant examines one or more interview requests via a component of assistant interview request manager 2007 (step 3601). If the assistant accepts the interview request via assistant interview request manager 2007 (step 3602), then proceed to step 3604. If the assistant denies the interview request via assistant interview request manager 2007 (step 3603), then proceed to step 3604. Next, the assistant interview request response may be pushed to the supervisor interview request manager (step 3604). If assistant wants to edit a profile (step 3406), then assistant device 500 displays one or more components of assistant profile manager 2006 (step 3407). Then, assistant device 500 edits one or more of the components previously input as part of assistant registration object 1900 (step 3408). If assistant wants to change their network (step 3409), then assistant device 500 displays reference network displayer 504 (step 3410) as detailed in (step 3701-step 3709) below.

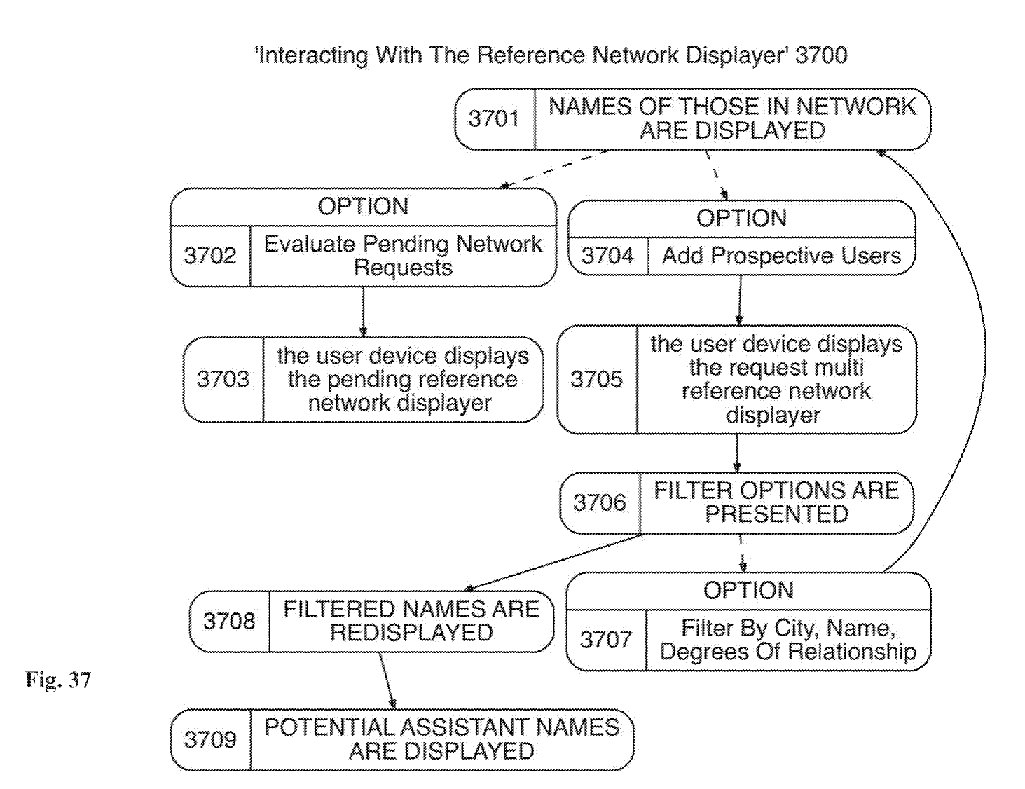

Now referring to FIG. 37, next, reference network displayer 504 loads multiple instances of users linked by network (step 3701). If the user indicates that they would like to evaluate pending network requests (step 3702), then the user device displays pending reference network displayer 2101 (step 3703). If the user indicates that they would like to add prospective users to their network (step 3704), then the user device displays request multi reference network displayer 2102 (step 3705). Next, filter options are presented (step 3706). If the assistant wants to search by city, name, degrees of relationship or any multiplicative combination of chosen attributes (step 3707), then proceed to step 3701. Next, user prompting may be displayed with people (step 3708). Next, reference network displayer 504 loads multiple instances of users linked by network (step 3709).

Now referring to FIG. 34, if an assistant wants to manage past supervisors (step 3411), then assistant device 500 displays one or more components of assistant past supervisor manager 2002 (step 3412) as detailed in (step 3801-step 3802) below.

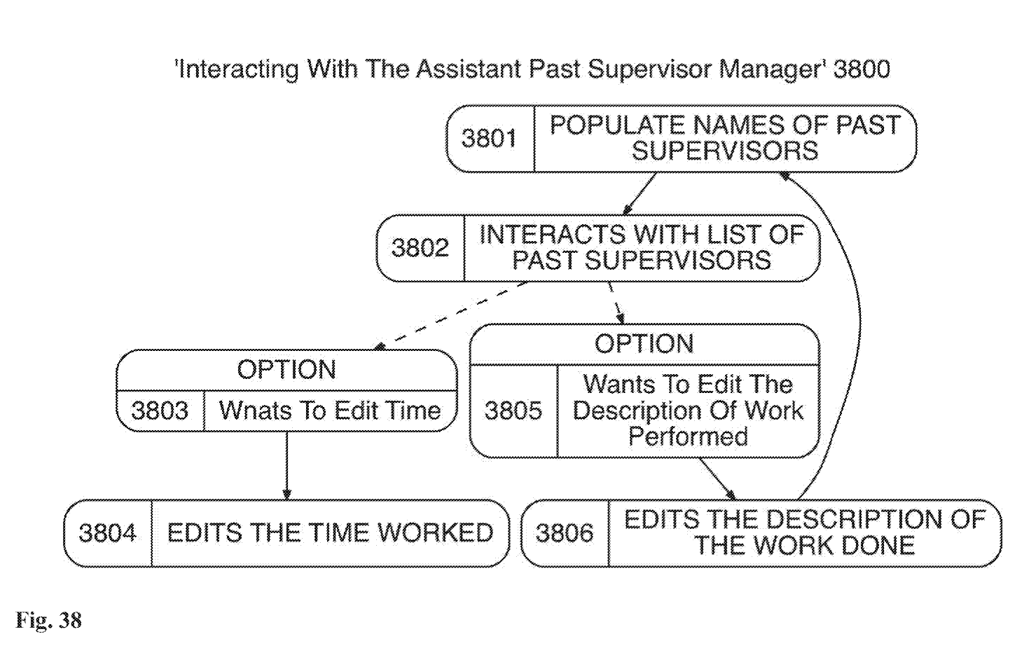

Now referring to FIG. 38, next, names populate assistant multi past supervisor displayer 2003 (step 3801). Next, user interacts with one or more of assistant past supervisor displayer 2004 (step 3802). If the user wants to edit the time worked (step 3803), then user edits the time worked (step 3804). If the user wants to edit the description of work performed (step 3805), then user edits the description of the work done (step 3806).

Now referring to FIG. 34, if assistant wants to examine how many profile views had happened (step 3413), then assistant device 500 displays who viewed the profile sorted by day/week/month (step 3414).

Now referring to FIG. 26, if the registration data associated with the device may be previously registered as supervisor device 501 (step 2608), then computing device 100 becomes supervisor device 501 and displays one or more components of supervisor workflow decider 2404 for interaction (step 2609) as detailed in (step 3901-step 3901) below.

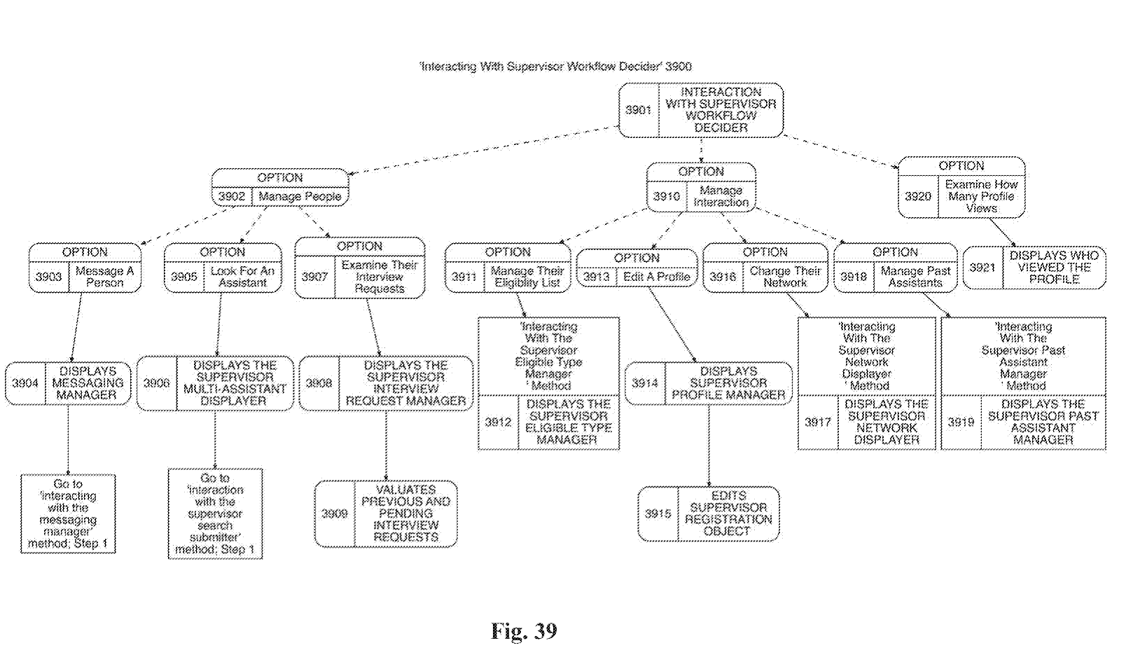

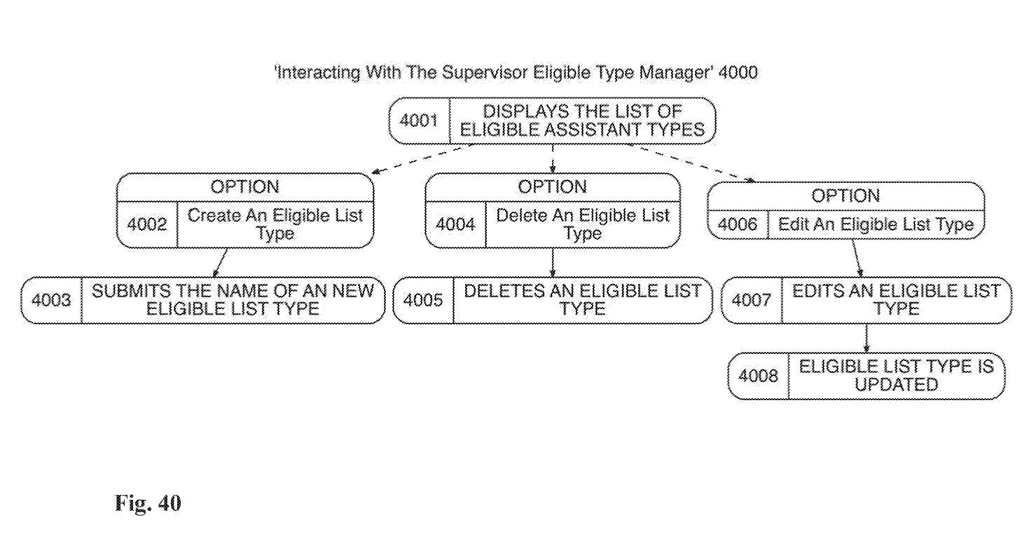

Now referring to FIG. 39, next, supervisor device 501 interacts with one or more components of supervisor workflow decider 2404 (step 3901). If supervisor wants to manage people (step 3902) and if supervisor wants to message a person (step 3903), then supervisor device 501 displays one or more components of messaging manager 509 (step 3904). If supervisor wants to look for an assistant (step 3905), then supervisor device 501 displays supervisor multi-assistant displayer 2300 (step 3906). If supervisor wants to examine their interview requests (step 3907), then supervisor device 501 displays the supervisor interview request manager (step 3908). Then, the supervisor evaluates previous and pending interview requests (step 3909). If supervisor wants to manage interaction with the site (step 3910) and if supervisor wants to manage their eligibility list (step 3911), then, supervisor device 501 displays supervisor eligible type manager 2407 may be displayed and may be interacted with (step 3912) as detailed in the steps below (referring to FIG. 40) below.

Now referring to FIG. 40, next, the supervisor device displays the list of eligible assistant types (step 4001). If the supervisor wants to create an eligible list type (step 4002), then the user submits the name of a new eligible list type (step 4003). If the supervisor wants to delete an eligible list type (step 4004), then the user deletes an eligible list type (step 4005). If the supervisor wants to edit an eligible list type (step 4006), then the user edits an eligible list type (step 4007). Then, the eligible list type may be updated (step 4008) and if supervisor wants to edit a profile (step 3913), then supervisor device 501 displays one or more components of supervisor profile manager 2403 (step 3914). Then, supervisor device 501 edits one or more of the components previously input as part of supervisor registration object 2205 (step 3915) and if supervisor wants to change their network (step 3916), then supervisor device 501 displays the supervisor network displayer (step 3917) as detailed in (step 4101-step 4106) below.

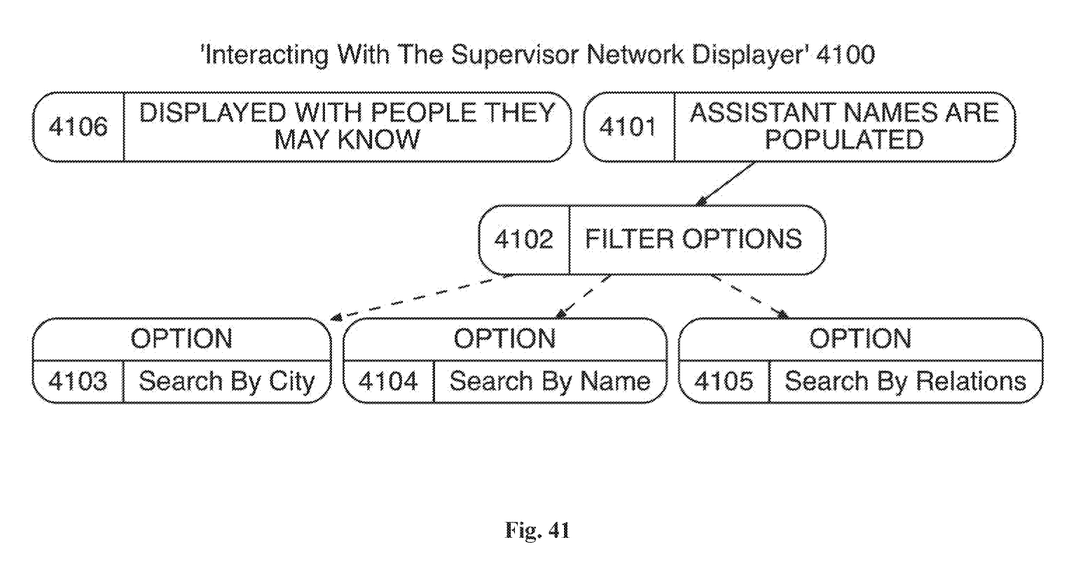

Now referring to FIG. 41, next, names populate the assistant network displayer of those in network (step 4101). Next, filter options are presented to the user (step 4102). If the assistant wants to search by city (step 4103). If the supervisor wants to search by name (step 4104). If the supervisor wants to search by web (step 4105). Next, user prompting may be displayed with people they may know (step 4106). If supervisor wants to manage past assistants (step 3918), then supervisor device 501 displays supervisor past assistant manager 2400 (step 3919) as detailed in (step 4201-step 4202) below.

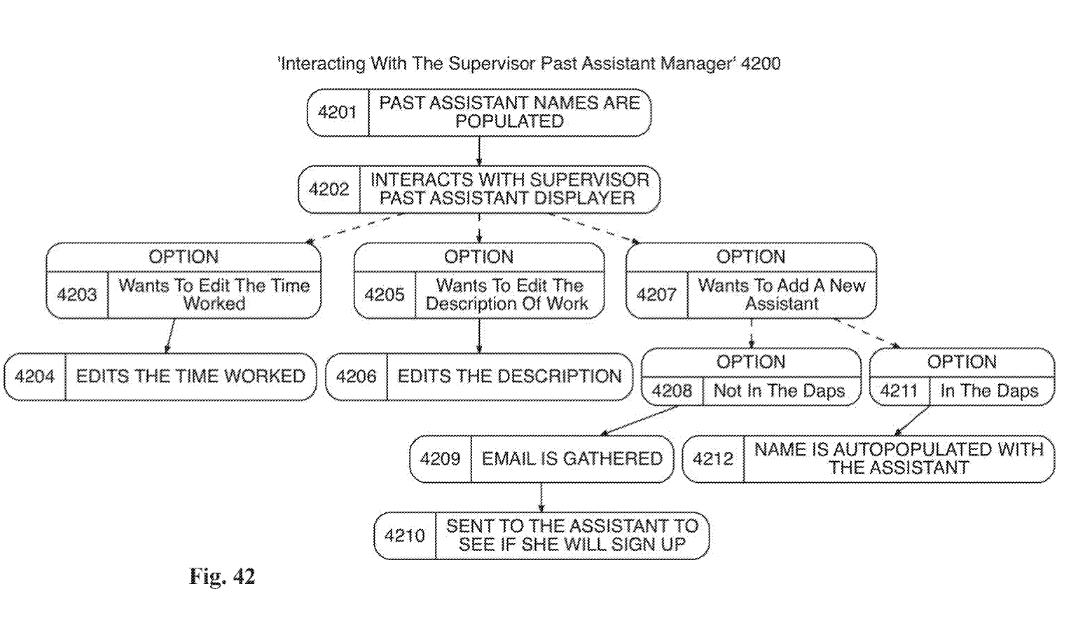

Now referring to FIG. 42, next, names populate supervisor multi past assistant displayer 2401 (step 4201). Next, user interacts with one or more of supervisor past assistant displayer 2402 (step 4202). If the user wants to edit the time worked (step 4203), then user edits the time worked (step 4204). If the user wants to edit the description of work performed (step 4205), then user edits the description of the work done (step 4206). If the user wants to add a new assistant (step 4207) and if the assistant may be not in DAPS 502 (step 4208), then the email may be gathered (step 4209). Then, an email may be sent to the assistant to see if she will sign up for DAPS 502 (step 4210) and if the assistant may be in DAPS 502 (step 4211), then the name may be auto populated with the assistant (step 4212). If supervisor wants to examine how many profile views had happened (step 3920), then supervisor device 501 displays who viewed the profile sorted by day/week/month (step 3921). Next, one or more devices interact with DAPS 502 for dynamic assistant prediction (step 2610).

The invention has some elements that are commonly known, and other terms defined as specific to this specification. These include: one or more computing device 100, one or more CPU 101, one or more processor 102, one or more local memory 103, one or more interface 104, one or more physical ports, one or more independent processor, one or more interface memory, one or more NIC, one or more busses, one or more memory 200, one or more nonvolatile memory 400, one or more storage devices 201, one or more input devices 202, one or more keyboard 401, one or more touchscreen, one or more microphone, mouse 402, touchpad, trackball, one or more input output units 403, one or more operating systems 203, one or more output devices 204, one or more real time clock 404, one or more power supply 405, one or more power source 406, one or more program instructions, distributed computing network 300, one or more client application 205, one or more client 301, one or more server 302, one or more external service 303, one or more shared services 206, one or more database 304, one or more security system 305, configuration system 306, one or more remote memory 105, one or more system server, one or more communications network 106, assistant device 500, supervisor device 501, and eligible assistant type. However, their use and relationships to the novel components and steps of the invention render them applicable herein. In order to preface the roles that they play in the specification, they are subsequently explained here.

In some embodiments, an example of an independent processor may be an audio processor or a video processor and the like. In some embodiments, an independent processor serves to allow communication with appropriate media. In some embodiments, an example of an interface memory may include volatile and/or non-volatile memory (e.g., RAM) and the like. NIC comprises a computer hardware component that connects a computer to a computer network.

Busses comprises a communication system that transfers data between components inside a computer, or between computers. Program instructions comprises a mechanism for control execution of system, or comprise of an operating system, and/or one or more applications. In some embodiments, examples of program instructions may include: an object code, a code produced by a compiler, a machine code, a code produced by an assembler or a linker, a byte code, a code executed using an interpreter, or a code on local memo. In some embodiments, program instructions serve to communicate with a plurality of other computing devices, such as clients or servers, over communications networks. In yet other embodiments, program instructions may also serve to implement the system and/or methods of the present invention. In yet other embodiments, program instructions may also serve to blocks of program instructions are modules, that may exist in different memory stores, or devices and perform comparable functions, though in different physical locations. Additionally, in other embodiments, the program instructions serve to program instructions (and modules that comprise them), that may exist on many types of memory 200, including but not limited to, non-volatile memory 400, local memory 103, interface memory, or storage devices 201. A system server comprises computing device 100. In some embodiments, a system server serves to communicate with a plurality of other computing devices, such as clients or servers, over communications networks.

An eligible assistant type comprises a designation of a plurality of identified assistant list views as being for a particular job type or purpose.

What is claimed is:

1. A system for dynamic assistant prediction comprising:
a network;
a dynamic assistant prediction computer connected to the network comprising a memory and a processor and further comprising programmable instructions stored in the memory and operating on the processor, the programmable instructions adapted to dynamically predict an assistant comprising:
a plurality of devices connected to the network, wherein a portion of the plurality of devices are supervisor devices, and a remaining portion of the plurality of devices are assistant devices;
an assistant reference network;
a device workflow parser;
a verification manager;
a dynamic matching manager;
a reference network displayer;
a messaging manager;
a housing manager;
a supervisor manager;
an assistant manager;
wherein the device workflow parser allows the designation of the role of the user for continued use of the system;
wherein the verification manager manages establishing the validity of the corroboration between instances of putative assistant data and putative supervisor data;
wherein the dynamic matching manager receives data from supervisor devices and assistant devices and to match supervisors and assistants;
wherein the reference network displayer manages interactions, storage, display and processing of the assistant reference network;
wherein the messaging manager is operable to manage interactions, via the network, between assistant devices and supervisor devices, wherein the assistant devices are operable to message other assistant devices, but are not operable to message the supervisor devices, and the supervisor devices are operable to message both the assistant devices and the supervisor devices;
wherein the housing manager is operable to manages interactions, via the network, between the plurality of assistant devices and the plurality of supervisor devices, further wherein the housing manager is further operable to coordinate housing arrangements for a putative working relationship between the assistant devices and the supervisor devices;
wherein the supervisor manager is operable to manage interactions, storage, display and processing of related functions of the supervisor device;
wherein the assistant manager is operable to manage interactions, storage, display and processing of related functions of the assistant device;
wherein the device workflow parser prompts for a first supervisor device registration data with the dynamic assistant prediction computer, wherein if device registration data associated with the first supervisor device is previously unregistered and if a request is received from the first supervisor device to search for an assistant, then a supervisor search is submitted;
wherein the reference network displayer loads multiple instances of the plurality of devices;
wherein if a request to evaluate a pending network request is received from a first device, of the plurality of devices, then the first device displays, at the network displayer, the pending reference network request,
wherein if a request is received to add one or more prospective users to a device network associated to the first device, then a request is sent to a network displayer associated to the first device to display a multi reference network.

2. The system of claim 1, wherein assistant data comprises, at least, length of time worked data, name data, description of work data, supervisor company name data, and supervisor company title data.

3. The system of claim 2, wherein the supervisor search comprises:
a dynamic matching manager;
a multiple instances of assistant registration object;
wherein the dynamic matching manager receives the assistant data to perform a search based on the assistant data:
wherein the dynamic matching manager receives an ordered list of assistant devices based on most experienced then most networked;
wherein the dynamic matching manager receives a filter request, the filter request is selected from the group consisting of filter by network, filter by financial, filter by experience, filter by ethos, filter by skills, and filter by assets.
